(19) United States
(12) Patent Application Publication
(10) Pub. No.: US 2003/0103022 A1
(43) Pub. Date: Jun. 5, 2003

(54) Display apparatus with function for initializing luminance data of optical element

(76) Inventors: Yukihiro Noguchi, Motosu-gun (JP); Shoichiro Matsumoto, Oogaki-City (JP); Hiroshi Tsuchiya, Hirakata-City (JP); Keiichi Sano, Anpachi-gun (JP)

Correspondence Address: MCDERMOTT, WILL & EMERY, 600 13th Street, N.W., Washington, DC, 20005-3096, US

(21) Appl. No.: 10/290,463

(22) Filed: Nov. 8, 2002

(30) Foreign Application Priority Data
Nov. 9, 2001 (JP) JP2001-344662
Nov. 9, 2001 (JP) JP2001-344663
Nov. 9, 2001 (JP) JP2001-344664
Jan. 10, 2002 (JP) JP2002-003973

(51) Int. Cl. G09G 3/30

(52) U.S. Cl. 345/77

(57) ABSTRACT

When the scanning line turns high and the first transistor turns on to write luminance data, a potential corresponding to the luminance data in the organic light emitting diode is set in both the gate electrode of the second transistor. At the same time, the fourth transistor turns on, and the electric charge in the anode of the organic light emitting diode is pulled out to ground potential by way of the fourth transistor. Also, at the same time, the third transistor turns off, so that any shoot-through current from the power supply line Vdd will be prevented. Thus the potential at the anode of the organic light emitting diode becomes the same as the ground potential. Thus, the luminance data already present in the optical element is initialized.

### BACKGROUND OF THE INVENTION

1. Field of the Invention

The present invention relates to a display apparatus and more particularly to a technology for improving the display quality of active-matrix type display apparatuses.

2. Description of the Related Art

The use of notebook personal computers and portable terminals is spreading rapidly. Displays mainly used for such equipment are liquid crystal displays, but the display considered promising as a next-generation flat display panel is the organic EL (Electro Luminescence) display. And the active matrix drive system is central as a display method for such displays. The display using this system is called the active matrix display where a multiplicity of pixels are vertically and horizontally disposed in a matrix, and a switching element is provided for each pixel. Image data are written into each pixel sequentially by the switching element.

The research and development of organic EL displays is now in the pioneer days, when a variety of pixel circuits are being proposed. One example of such circuits is a pixel circuit disclosed in Japanese Patent Application Laid-Open No. Hei11-219146, which will be briefly explained hereinbelow with reference to FIG. 9.

This circuit is comprised of a first and a second transistor Tr11 and Tr12, which are two n-channel transistors, an organic light emitting diode OLED, which is an optical device, a storage capacitance SC11, a scanning line SL, a power supply line Vdd and a data line DL which inputs luminance data.

This circuit operates as follows. To write luminance data of the organic light emitting diode OLED, the scanning line SL turns high and the first transistor Tr11 turns on, and luminance data inputted to the data line DL is set in both the gate electrode of the second transistor Tr12 and the storage capacitance SC11. At the timing of luminescence, the scanning line SL becomes low, thereby turning the first transistor Tr11 off and thus holding voltage at the gate of the second transistor Tr12, so that luminescence takes place according to the set luminance data.

When the luminance data set for an optical element or a driving transistor is large, an attempt to set smaller luminance data by rewriting the luminance data may often end in an residual image phenomenon, where an electric charge corresponding to the previous large luminance data remains in the optical element without being drained completely and thus the desired luminance data cannot be set accurately. When this happens, images become very hard to see especially when quickly moving pictures are to be displayed.

### SUMMARY OF THE INVENTION

The present invention has been made in view of the foregoing circumstances and an object thereof is to provide a new circuitry that can reduce the occurrence of the above-mentioned residual image phenomenon. Another object thereof is to realize a saving of power consumption by a display apparatus.

A preferred embodiment according to the present invention relates to a display apparatus. This apparatus includes a current bypass element in parallel with an optical element, wherein voltage having occurred across the optical element is initialized by controlling the current bypass element in accordance with an operation to set luminance data in the optical element. Moreover, the display apparatus may further include a switch which shuts off a path that supplies current to the optical element when the current bypass element turns on.

Moreover, a data update instructing signal for setting the luminance data and a signal for controlling said current bypass element may be combined into a common signal, and the luminance data may be set simultaneously with the initialization of voltage having occurred across the optical element. Here, the data update instructing signal, which is generally a scanning signal, is inputted to a scanning line. Moreover, the data update instructing signal for setting luminance data and the signal for controlling the current bypass element may be provided separately from each other, so that timing can be set for the initialization of voltage having occurred across the optical element. In other words, a wiring different from the scanning line is provided to control a switch that supplies current to the current bypass element and optical element. This enables initialization of voltage having occurred across the optical element without being restricted by the timing of scanning.

When an active matrix display apparatus is assumed, each pixel is generally comprised of an optical element, a drive circuit, a data line, a scanning line and a power supply line. Moreover, a path connecting the power supply line with the drive circuit, optical element and ground potential in series is formed, and a current of desired value is thereby allowed to flow to the optical element. Here, a bypass including a switching element is provided between an anode of the optical element and the ground potential. Moreover, a switching element which shuts off power supply from the power supply line to the optical element is provided between the drive circuit and the power supply line or between the drive circuit and the optical element.

When the switching element provided in the bypass is turned on, the anode of the optical element is short-circuited to the ground potential, thus gaining the same potential as the ground potential. Moreover, at the same time, a shoot-through current flowing from the power supply line to the ground potential is suppressed by turning off the switching element provided between the power supply line and the drive circuit.

Moreover, when voltage having occurred across the optical element is initialized, a reverse voltage where a voltage to be applied on the occasion of causing the optical element to emit light is a positive voltage may be applied across the optical element. In other words, the optical element may be put to the state of a reverse bias being applied at which time the optical element is caused to emit light.

What may be assumed here as an optical element is an organic light emitting diode, but is not limited thereto. Moreover, what may be assumed here as a current bypass element or switching element is an MOS (Metal Oxide Semiconductor) transistor or a TFT (Thin Film Transistor), but is not limited thereto. Moreover, “luminance data” means data concerning luminance or brightness information to be set in a driving transistor, and is distinguished from the intensity of light emitted by the optical element.

Another preferred embodiment according to the present invention also relates to a display apparatus. This apparatus comprises: an optical element which has a first terminal through which current enters, and a second terminal that allows the current to exit; and an initializing element which actively discharges electric charge accumulated on a side of the first terminal for a predetermined period when current to flow to the optical element is changed. Here, the initializing element is a switching element connected in parallel with the optical element, and when the switching element turns on, the electrical charge at the anode of the optical element is pulled out through the switching element to the ground potential.

Still another preferred embodiment according to the present invention also relates to a display apparatus. This apparatus comprises: an optical element which has a first terminal through which current enters and a second terminal that allows the current to exit; and an initializing element which stores electric charge on a side of the first terminal for a predetermined period when current to flow to the optical element is changed. Moreover, the initializing element may operate in a manner such that potential of the second terminal is higher than that of the first terminal for a predetermined period.

Still another preferred embodiment according to the present invention also relates to a display apparatus. This apparatus has a switching element in a path connecting an optical element in series with a drive circuit therefor, and the path is opened and closed by controlling the switching element according to an operation that sets luminance data in the drive circuit. A data update instructing signal for setting the luminance data may be connected to the switching element, and the switching element may be turned off during setting of the luminance data. Here, the data update instructing signal is generally a signal which selects a pixel that luminance data is to be written to.

For example, a switching element may be provided in a path which connects a drive circuit, an optical element and ground potential in series from a fixed potential which is normally a source voltage. The switching element may be positioned either between the optical element and the drive circuit or between the fixed potential and the drive circuit. The connection may be in the order of optical element, drive circuit and ground potential from the source voltage, wherein the switching element may be provided between the source voltage and the optical element.

Still another preferred embodiment according to the present invention also relates to a display apparatus. This apparatus is such that each pixel includes an optical element, a driving transistor and a power shutoff transistor, wherein the optical element, the driving transistor and the power shutoff transistor are connected in series with each other, a starting point of the series system is connected to a fixed potential which supplies current to the optical element, and the power shutoff transistor is disposed on a fixed potential side of the optical element.

Still another preferred embodiment according to the present invention also relates to a display apparatus. This apparatus is such that each pixel includes an optical element, a driving transistor and a power shutoff transistor, wherein the driving transistor and the power shutoff transistor are p-channel transistors, and wherein the optical element, the driving transistor and the power shutoff transistor are connected in series with each other, a starting point of the series system is connected to a fixed potential which supplies current to the optical element, and the power shutoff transistor is disposed on a fixed potential side of the optical element.

Moreover, the drive transistor and the power shutoff transistor may be a combination of n-channel transistor and p-channel transistor. If the power shutoff transistor is of the reversed polarity to a switching element which inputs luminance data to a drive circuit, a control signal which turns the power shutoff transistor on and off can be commonly used also as a signal for controlling the switching element which inputs the luminance data to the drive circuit.

Still another preferred embodiment according to the present invention also relates to a display apparatus. This apparatus comprises: an optical element which has a first terminal through which current enters, and a second terminal that allows the current to exit; and an initializing element which prompts a discharge of electric charge accumulated on a side of the first terminal for a predetermined period when current to flow to the optical element is changed. The initializing element may be such that the optical element per se operates to discharge the electric charge by shutting off a path of current flowing to the first terminal. The potential difference across the optical element resulting from this discharge will be a voltage determined by the length of time during which the path is shut off, a time constant of the element and a potential difference immediately prior thereto. Such a voltage value is permissible as long as it is at a level that does not adversely affect the image display.

Still another preferred embodiment according to the present invention also relates to a display apparatus. This display apparatus is such that luminance data to be set for an optical element is stored in the form of a control voltage and there are provided a write period to be set again by changing the luminance data and an initialization period for discharging electric charge generated across the optical element. A signal for activating the write period and a signal for activating the initialization period may be put to a common use so as to cause to generate the both periods simultaneously. As these signals, a scanning signal which is inputted to a scanning line as a update signal of the luminance data may be generally assumed. Moreover, the write period and the initialization period may be simultaneously generated, and a path that supplies current to the optical element is shut off during those periods. Moreover, a signal for activating the write period and a signal for activating the initialization period may be provided separately, and the initializing period may be set arbitrarily.

When assumed is an active-matrix type display apparatus, each pixel is generally comprised of an optical element, a drive transistor, a data line, a scanning line and a power supply line. Moreover, a path connecting the driving circuit, optical element and ground potential in series from the power supply line is formed, and a desired current flows to the optical element. Here, a switching element is provided between the drive circuit and the power supply line or between the drive circuit and the optical element, and the switching element is turned off, during a write period to be set again, by changing the luminance data, so that the electric charge in the optical element is prompted to be discharged and the optical element is initialized. Moreover, the switching element, optical element and drive circuit may be connected in series, in this order, from the power supply line.

As another embodiment, a switching element is provided between an anode of the optical element and ground potential so as to form a bypass, in addition to provision of a switching element between the drive circuit and the power supply line. This switching element turns on and thereby electric charge at the anode of the optical element is pulled to ground potential. The optical element is initialized by making potential at the anode of the optical element equal to the ground potential.

Still another preferred embodiment according to the present invention also relates to a display apparatus. This apparatus is such that each pixel includes an optical element, a driving transistor and a power shutoff transistor, wherein the power shutoff transistor is turned off during a period in which a data update instructing signal for writing luminance data of the optical element to the driving transistor is being activated, so that a path which supplies current to the optical element is cut off, and wherein the power shutoff transistor is turned on after a write period of the luminance data to the driving transistor ends, so that the current supplying path that has been cut off is connected. That the current supplying path is cut off causes to discharge electric charge generated across the optical element.

Still another preferred embodiment according to the present invention also relates to a display apparatus. This display apparatus comprises: an optical element; a drive element which drives the optical element; and a switch element which controls setting timing that sets a drive capacity of the drive element, wherein the switch element is controlled by a scanning signal, and dummy luminance data is set in the drive element by a scanning signal for an optical element controlled temporally prior to the optical element.

A “selection signal” is used to control the on-off of the switch element in a manner that the selection signal is directly or secondarily processed, and the signal line thereof is separately provided for each pixel line. This selection signal will be referred to also as “scanning signal” hereinafter. The “dummy luminance data” is a value different from luminance data which is to be set originally to the drive element, and the “dummy luminance data” is set temporarily before the proper luminance data is set. For example, a value which sets the optical element to an off state may be set as the dummy luminance data.

A path of the scanning signal for an optical element controlled temporally prior thereto and a path of the luminance data to be set in the drive element may be coupled in capacity. In such a case, when the scanning signal for the optical element controlled temporally prior thereto is activated, a value of the luminance data which is in a floating state between the switch element and the drive element is changed, via said capacity, to a direction of becoming the dummy luminance data.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a circuit for a pixel of a display apparatus according to a first embodiment of the present invention.

FIG. 2 shows a circuit for a pixel of a display apparatus according to a second embodiment of the present invention.

FIG. 3 shows a circuit for a pixel of a display apparatus according to a third embodiment of the present invention.

FIG. 4 shows another circuit for a pixel of a display apparatus according to the third embodiment of the present invention.

FIG. 5 shows a generalized circuit over those in the first and second embodiments.

FIG. 6 shows a generalized circuit over that in the third embodiment.

FIG. 7 shows a generalized circuit over that shown in FIG. 5.

FIG. 8 shows a generalized circuit over that shown in FIG. 6.

FIG. 9 shows a circuit for a pixel according to the conventional art.

FIG. 10 shows a circuit for a pixel of a display apparatus according to a fourth embodiment of the present invention.

FIG. 11 shows another circuit for a pixel of a display apparatus according to the fourth embodiment.

FIG. 12 shows a multi-layer structure of an organic light emitting diode.

FIG. 13 shows another multi-layer structure of the organic light emitting diode.

FIG. 14 shows an example of a pixel circuit suitable for the organic light emitting diode having such a structure shown in FIG. 12.

FIG. 15 shows an example of the pixel circuit suitable for the organic light emitting diode having such a structure shown in FIG. 13.

FIG. 16 shows a circuit for a pixel of a display apparatus according to a sixth embodiment of the present invention.

FIG. 17 shows another circuit for a pixel of the display apparatus according to the sixth embodiment of the present invention.

FIG. 18 shows a circuit for a pixel of a display apparatus according to a seventh embodiment of the present invention.

FIG. 19 shows another circuit for a pixel of the display apparatus according to the seventh embodiment of the present invention.

FIG. 20 shows a modified pixel circuit according to the seventh embodiment.

FIG. 21 shows another modified pixel circuit according to the seventh embodiment.

FIG. 22 shows still another modified pixel circuit according to the seventh embodiment.

FIG. 23 shows a circuit structure for two pixels of a display apparatus according to an eighth embodiment.

FIG. 24 is a timing chart showing relationships between the state of scanning signals and the emission time and non-luminescent time in a display apparatus according to the eighth embodiment.

FIG. 25 shows a circuit structure for one pixel of a display apparatus according to a ninth embodiment.

FIG. 26 shows a circuit structure for two pixels of a display apparatus according to a tenth embodiment.

FIG. 27 shows a circuit structure for three pixels of a display apparatus according to a thirteenth embodiment.

FIG. 28 shows a modified circuit structure over that shown in FIG. 23

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the following embodiments, an active matrix organic EL (Electro Luminescence) display is assumed as a display apparatus. In these embodiments, novel circuitry that reduces the above-mentioned residual image phenomenon will be proposed. Accordingly, a bypass including a switching element is provided in parallel from the anode of an optical element to ground potential, and electric charge in the optical element is released to ground potential by turning on and off a switching element at predetermined timing so as to initialize luminance data in the optical element.

First Embodiment

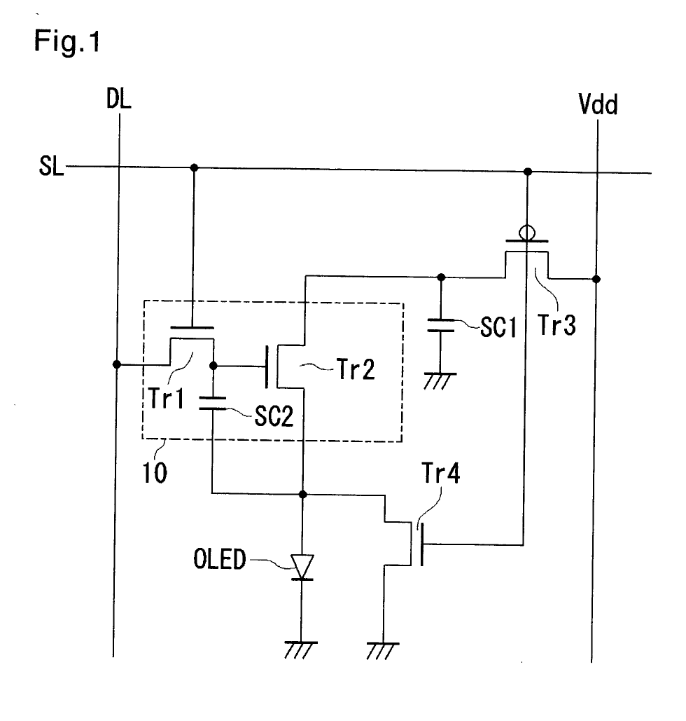

FIG. 1 shows a circuit for a pixel of a display apparatus according to a first embodiment of the present invention. The pixel is comprised of an organic light emitting diode OLED which is an optical element, a drive circuit 10, first and second storage capacitances SC1 and SC2, and a fourth transistor Tr4 and a third transistor Tr3 which function as switching elements. The drive circuit 10 is further comprised of a first transistor Tr1 and a second transistor Tr2.

The pixel is further comprised of a data line DL to which luminance data is inputted, a power supply line Vdd which supplies current to the organic light emitting diode OLED, and a scanning line SL to which luminance data updating signals are inputted. The data line DL, power supply line Vdd and scanning line SL are shared by the other pixels.

Moreover, whereas the first, second and fourth transistors Tr1, Tr2 and Tr4 are n-channel transistors, the third transistor Tr3 is a p-channel transistor.

Gate electrodes of the first, fourth and third transistors Tr1, Tr4 and Tr3 are each connected to the scanning line DL. A drain electrode (or a source electrode) of the first transistor Tr1 is connected to the data line DL, and the source electrode (or the drain electrode) of the first transistor Tr1 and a gate electrode of the second transistor Tr2 are connected to one electrode of the second storage capacitance SC2. A source electrode of the second transistor Tr2, an anode of the organic light emitting diode OLED, and the other electrode of the second storage capacitance SC2 are connected to a drain electrode of the fourth transistor Tr4. A cathode of the organic light emitting diode OLED and a source electrode of the fourth transistor Tr4 are each connected to ground potential. A drain electrode of the second transistor Tr2 and one electrode of the first storage capacitance SC1 are connected to a drain electrode of the third transistor Tr3. The other electrode of the first storage capacitance SC1 is connected to ground potential. A source electrode of the third transistor Tr3 is connected to the power supply line Vdd.

Thus, from the power supply line Vdd to the ground potential, the third and second transistors Tr3 and Tr2 and the organic light emitting diode OLED, in this order, are connected in series to form a main path. Also formed from the anode of the organic light emitting diode OLED is a bypass including the fourth transistor Tr4.

The operation by this circuit will be explained hereinbelow. When the scanning line SL turns high and the first transistor Tr1 turns on to write luminance data, a potential corresponding to the luminance data in the organic light emitting diode OLED is set in both the gate electrode of the second transistor Tr2 and the storage capacitance SC2. At the same time, the fourth transistor Tr4 turns on, and the electric charge in the anode of the organic light emitting diode OLED is pulled out to ground potential by way of the fourth transistor Tr4. Also, at the same time, the third transistor Tr3 turns off, so that any shoot-through current from the power supply line Vdd will be prevented. Thus the potential at the anode of the organic light emitting diode OLED becomes the same as the ground potential.

Then, at the timing of luminescence, the scanning line SL turns low, which makes the first and fourth transistors Tr1 and Tr4 turn off and the third transistor Tr3 turn on. Thereby, a current corresponding to the luminance data set in the second transistor Tr2 flows from the power supply line Vdd to the organic light emitting diode OLED.

According to the first embodiment, at the writing of luminance data, the luminance data already present in the optical element is initialized, so that the residual image phenomenon often seen at the rewriting of large luminance data by smaller luminance data can be reduced. At the same time, the supply of current from the power supply line to the drive circuit is shut off, so that reduction of current consumption is realized.

Second Embodiment

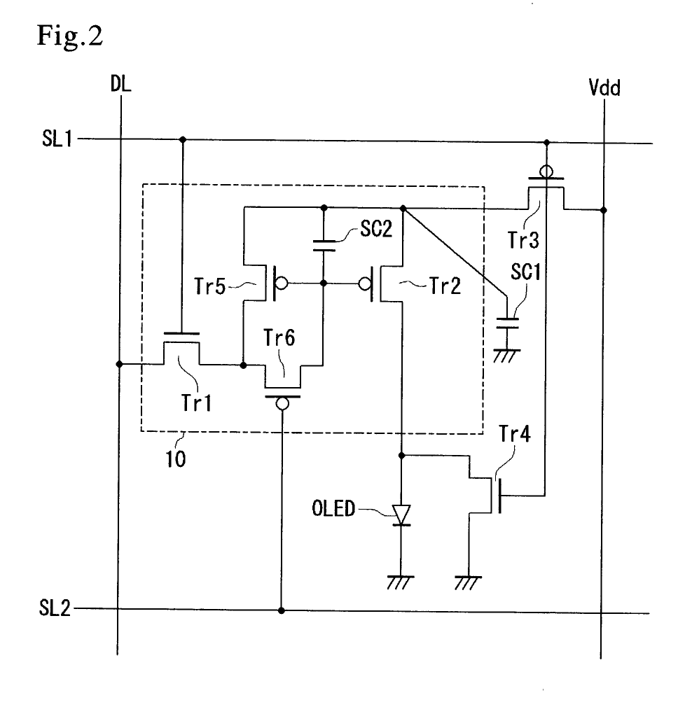

FIG. 2 shows a circuit for a pixel of a display apparatus according to a second embodiment of the present invention. The pixel is comprised of an organic light emitting diode OLED which is an optical element, a drive circuit 10, first and second storage capacitances SC1 and SC2, fourth and third transistors Tr4 and Tr3 which function as switching elements, a data line DL, a power supply line Vdd, and first and second scanning lines SL1 and SL2. The drive circuit 10 is further comprised of first, second, fifth and sixth transistors Tr1, Tr2, Tr5 and Tr6. The first and fourth transistors Tr1 and Tr4 are n-channel transistors, whereas the second, third, fifth and sixth transistors Tr2, Tr3, Tr5 and Tr6 are p-channel transistors.

Gate electrodes of the first, third and fourth transistors Tr1, Tr3 and Tr4 are each connected to the first scanning line SL1, and a gate electrode of the sixth transistor Tr6 is connected to the second scanning line SL2. A drain electrode (or a source electrode) of the first transistor Tr1 is connected to the data line DL. The source electrode (or the drain electrode) of the first transistor Tr1 and a drain electrode (or a source electrode) of the fifth transistor Tr5 are connected to a drain electrode of the sixth transistor Tr6. Gate electrodes of the fifth and second transistors Tr5 and Tr2 and the source electrode (or the drain electrode) of the sixth transistor Tr6 are connected to one of the two electrodes of the second storage capacitance SC2. Source electrodes of the second and fifth transistors Tr2 and Tr5, a drain electrode of the third transistor Tr3, and the other electrode of the second storage capacitance SC2 are connected to one of the two electrodes of the first storage capacitance SC1. A source electrode of the third transistor Tr3 is connected to the power supply line Vdd, and the other electrode of the first storage capacitance SC1 is connected to ground potential. Drain electrodes of the second and fourth transistors Tr2 and Tr4 are each connected to an anode of the organic light emitting diode OLED. A cathode of the organic light emitting diode OLED and a source electrode of the fourth transistor Tr4 are connected to ground potential.

The operation by this circuit will be explained hereinbelow. When the first scanning line SL1 turns high and the second scanning line SL2 turns low to write luminance data, the first, fourth and sixth transistors Tr1, Tr4 and Tr6 turn on and the third transistor Tr3 turns off. The gate electrode and the drain electrode of the fifth transistor Tr5 are short-circuited, so that the fifth transistor Tr5 operates within an unsaturated domain and the gate electrode of the fifth transistor Tr5 and the gate electrode of the second transistor Tr2 have the same potential. Thus, luminance data is set in the second transistor Tr2. At this time, a path from the power supply line Vdd is shut off as the third transistor Tr3 turns off. And, since the fourth transistor Tr4 is on, the electric charge in the anode of the organic light emitting diode OLED is drained off to ground potential by way of the fourth transistor Tr4 and thus the potential at the anode of the organic light emitting diode OLED drops to the ground potential.

At the timing of luminescence, the first scanning line SL1 turns low and the second scanning line SL2 turns high, which makes the first, fourth and sixth transistors Tr1, Tr4 and Tr6 turn off and the third transistor Tr3 turn on. Thereby, a current corresponding to the luminance data set in the second transistor Tr2 flows to the organic light emitting diode OLED.

According to the second embodiment, advantageous effects similar to the first embodiment are obtained.

Third Embodiment

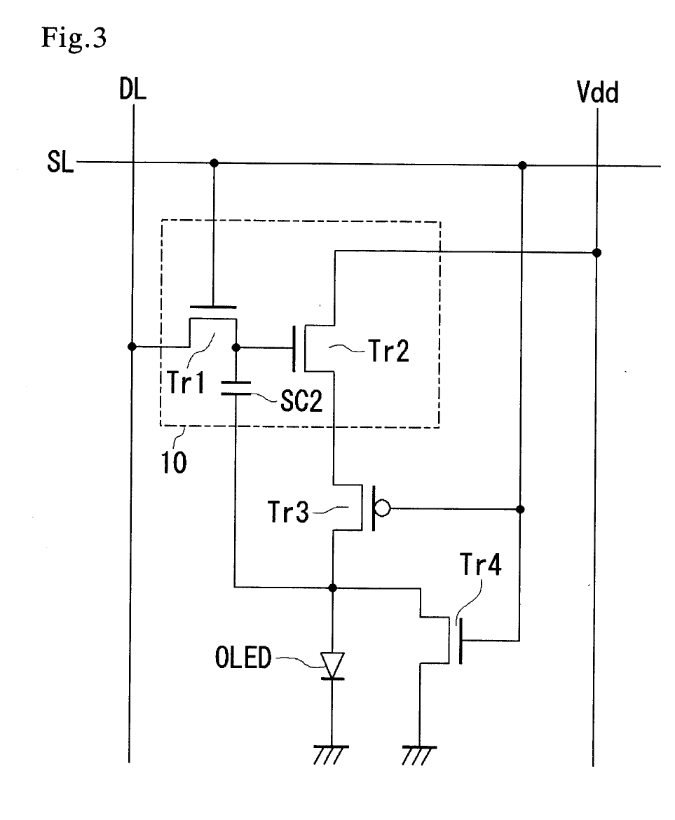

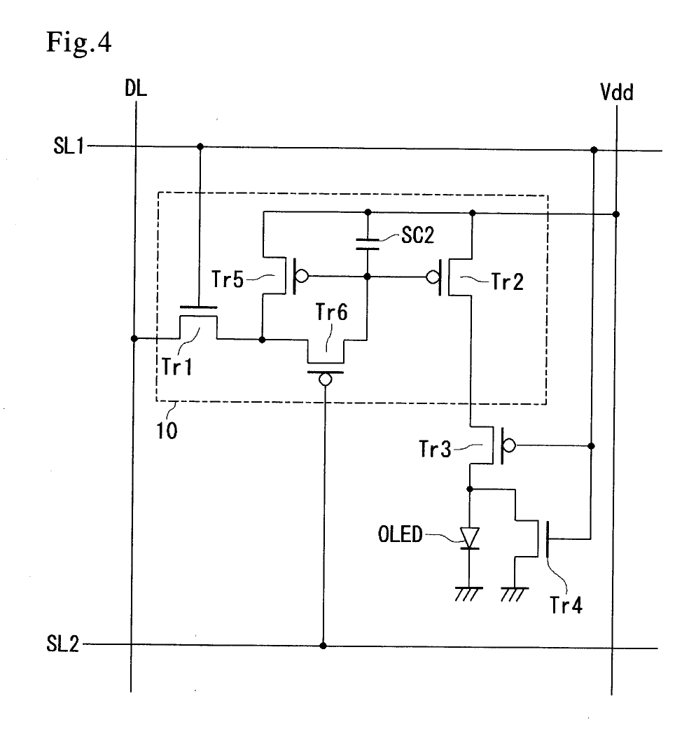

FIGS. 3 and 4 show circuits for a pixel of a display apparatus according to a third embodiment of the present invention. In the first and second embodiments, a third transistor Tr3 which functions as a switching element is provided between a power supply line Vdd and a drive circuit 10. In the third embodiment, however, the above-mentioned transistor Tr3 is provided between a drive circuit 10 and an organic light emitting diode OLED. Thus, in the circuit shown in FIG. 3, the third transistor Tr3 and the second transistor Tr2 in the circuit shown in FIG. 1 according to the first embodiment are replaced with each other in the order of connection. Similarly, in the circuit shown in FIG. 4, the third transistor Tr3 and the second transistor Tr2 in the circuit shown in FIG. 2 according to the second embodiment are replaced with each other in the order of connection.

The description of operations of these circuits is omitted here because the operations thereof are basically the same as those of the circuits according to the first and second embodiments. Advantageous effects obtained therefrom are also the same. In the first and second embodiments, the first storage capacitance SC1 is provided to suppress the effect on luminance data, namely, the effect on the gate electrode of the second transistor Tr2, that can occur when the third transistor Tr3 is turned off. In the third embodiment, however, the third transistor Tr3, which is placed between the second transistor Tr2 and the organic light emitting diode OLED, works to eliminate the effect on the gate electrode of the second transistor Tr2.

The present invention has been described based on embodiments which are only exemplary. It is understood by those skilled in the art that there exist other various modifications to the combination of each component and each processing described and that such modifications are encompassed by the scope of the present invention. Such modifications will be described hereinbelow.

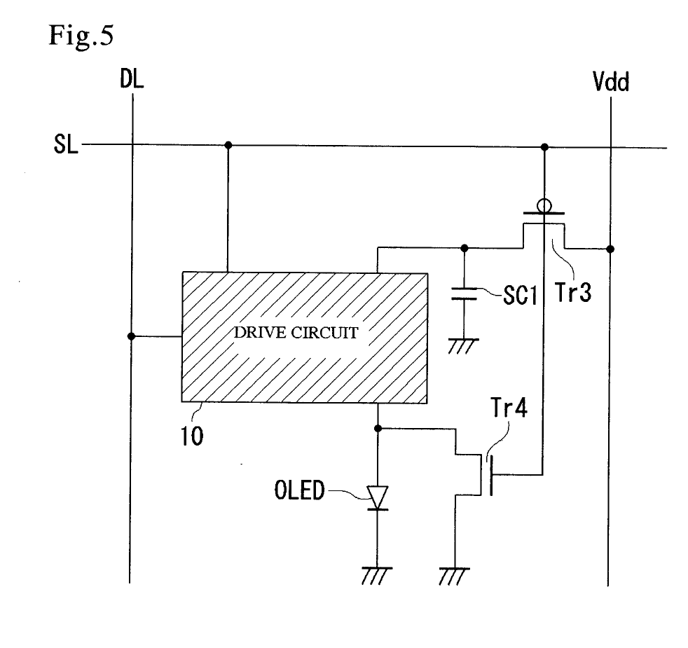

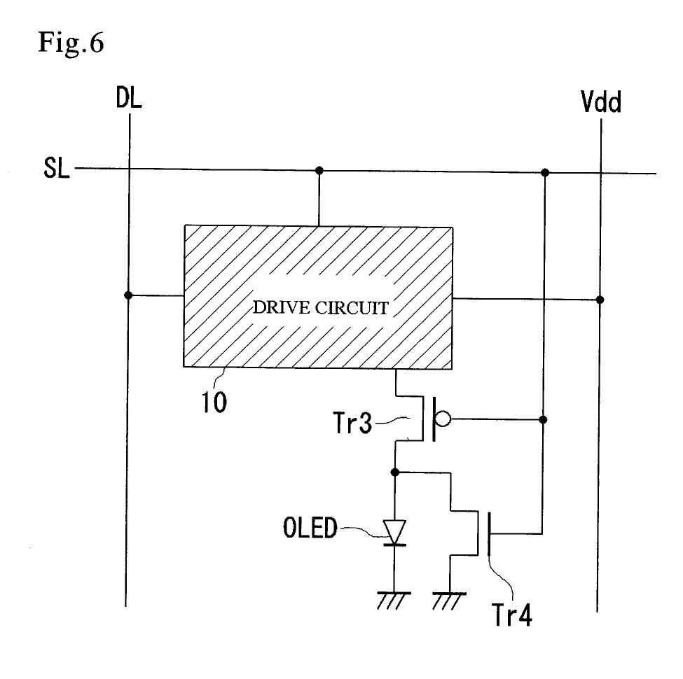

In the first to third embodiments, the drive circuit 10 shown in FIGS. 1 through 4 is assumed as a drive circuit, but there should be no limitation thereto. Since there are a variety of this drive circuit, a circuit to which the present invention applies can be represented generally as shown in FIG. 5 and FIG. 6. FIG. 5 shows a generalized circuit over those in the first and second embodiments, whereas FIG. 6 shows a generalized circuit over that in the third embodiment.

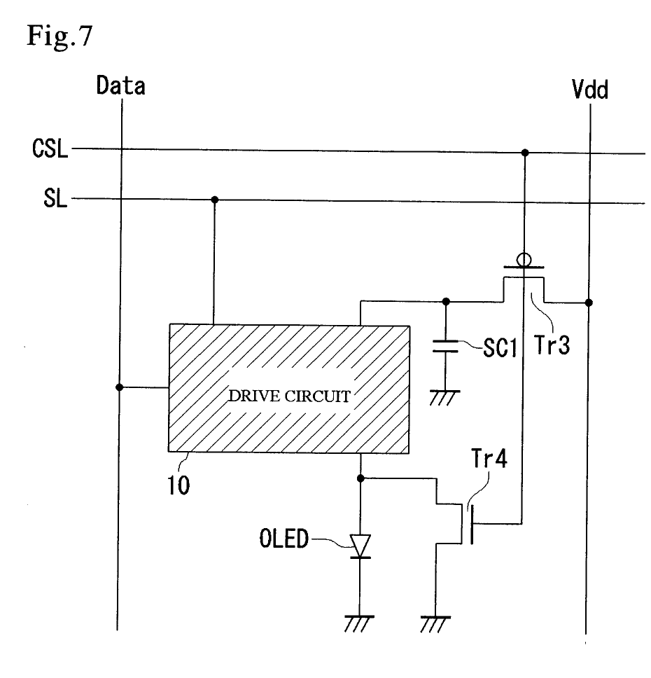

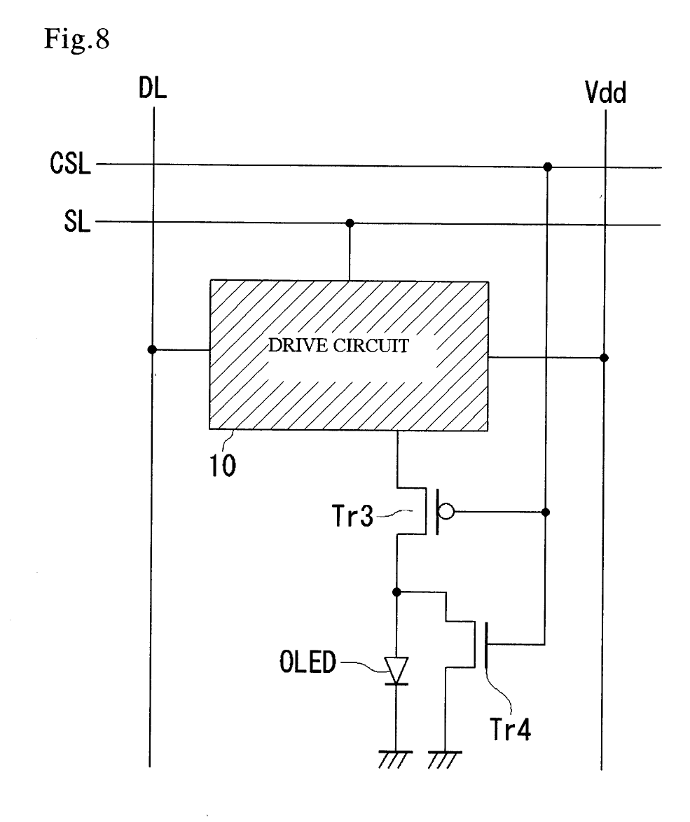

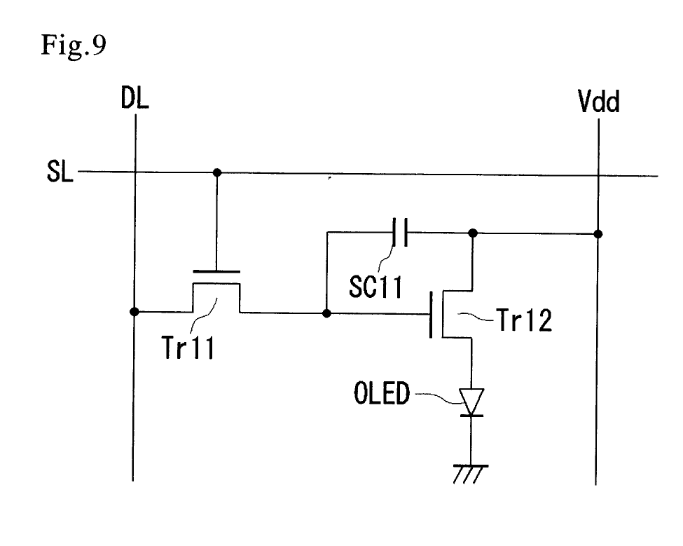

In the above embodiments, the scanning line SL linked to the drive circuit for the same pixel is used to turn on and off the third and fourth transistors Tr3 and Tr4, but this may be done by linking to a scanning line which is one scanning preceding in time. Such an arrangement can reduce coupling noise that may result from the operation of the scanning line SL on write data. Moreover, an exclusive-use wiring may be provided separately to turn on and off the third and fourth transistors Tr3 and Tr4. Circuits shown in FIG. 7 and FIG. 8 are, respectively, generalized circuits shown in FIG. 5 and FIG. 6, provided, as mentioned above, with a control line CSL for turning on and off the third and fourth transistors Tr3 and Tr4. This arrangement removes temporal restriction on the scanning line SL, so that luminescence of a pixel can be controlled at arbitrary timing. In other words, the luminescence time (also referred to as emission time hereinafter) can be adjusted by controlling the control line CSL, thereby adjusting white balance and luminance.

In the above embodiments, a relief exit of the current flowing through the bypass, namely, the source electrode of the fourth transistor Tr4, is connected to ground potential, but there should be no limitation thereto. For example, the exit may be set equal to a threshold voltage of the organic light emitting diode OLED, which will improve the luminescence response of the organic light emitting diode OLED. Moreover, it may be set at a negative potential. In that case, electric charge is drained off quickly.

Fourth Embodiment

A fourth embodiment is characterized by a feature that a bias to be applied to an organic light emitting diode OLED at initializing luminance data is reversed, and that a source electrode of a transistor provided as a bypass is set at a negative potential or a potential lower than that at the cathode of the organic light emitting diode OLED.

In the above embodiments, the source electrode of the fourth transistor Tr4 forming a bypass relative to the organic light emitting diode OLED is connected to ground potential and the potential thereof is set at the same level as the potential at the cathode of the organic light emitting diode OLED, but there should be no limitation thereto. For example, the source electrode of the fourth transistor Tr4 may be set at a potential lower than that at the cathode of the organic light emitting diode OLED.

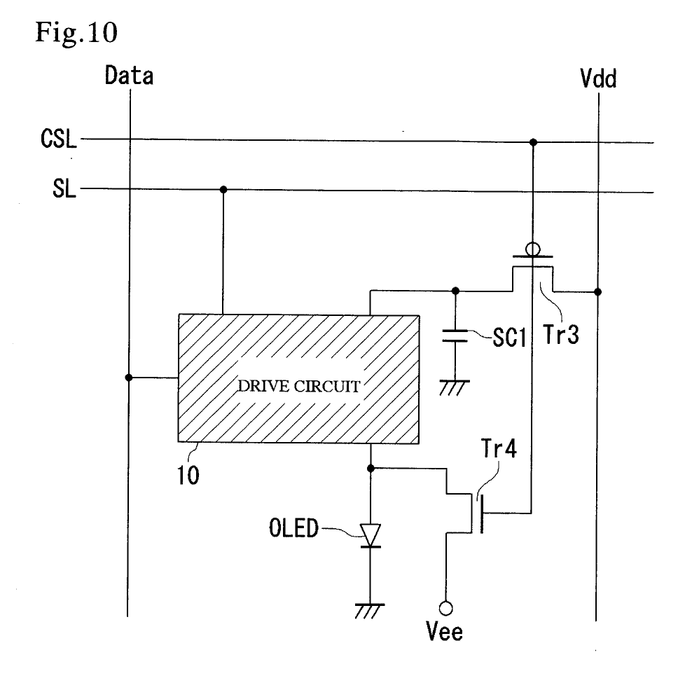

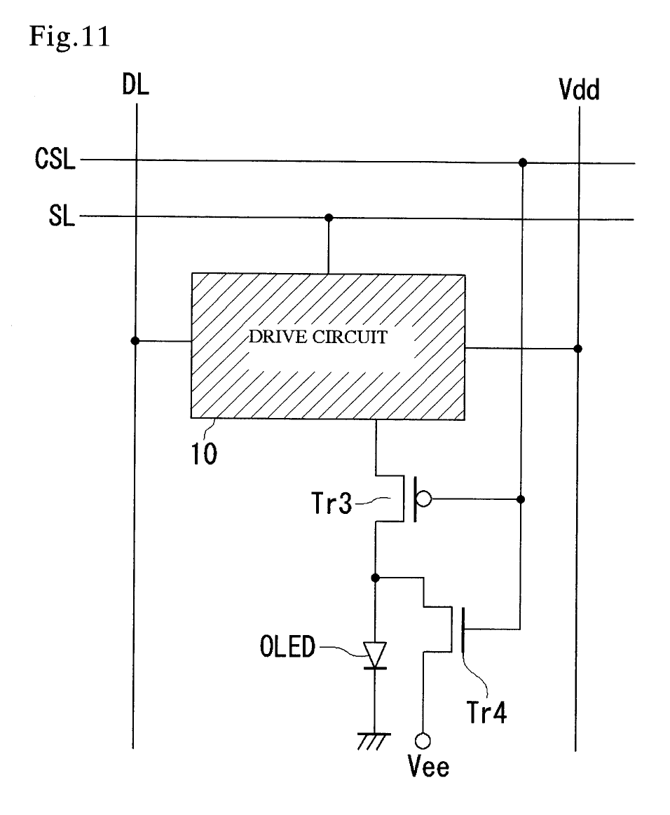

FIG. 10 shows a circuit for a pixel shown in FIG. 7, where the source electrode of the fourth transistor Tr4 is connected to a negative potential Vee that is lower than that at the cathode of the organic light emitting diode OLED. Similarly, FIG. 11 shows a circuit for a pixel shown in FIG. 8, where the source electrode of the fourth transistor Tr4 is connected to a negative potential Vee that is lower than that at the cathode of the organic light emitting diode OLED. As a control line CSL turns high, a third transistor Tr3 turns off and the fourth transistor Tr4 turns on. At this time, the potential at the anode of the organic light emitting diode OLED becomes a negative potential Vee which is the same as the potential of the source electrode of the fourth transistor Tr4. The potential at the cathode of the organic light emitting diode OLED is equal to ground potential, which is higher than the potential at the anode thereof, so that a bias is applied in the direction opposite to that in ordinary operation. Namely, the potential at the anode of the organic light emitting diode OLED drops lower than the potential at the cathode thereof.

With a reverse bias applied to the organic light emitting diode OLED, the electric charge remaining in the anode of the organic light emitting diode OLED is drained off to suppress any residual image phenomenon, and at the same time, the characteristics of organic film constituting the organic light emitting diode OLED can be recovered. Here, the source electrode of the fourth transistor Tr4, whose on and off is controlled by a scanning line SL and a separate control line CSL, is set at a negative potential Vee lower than the potential at the cathode of the organic light emitting diode OLED, but there should be no limitation thereto. For example, in a circuit where the fourth transistor Tr4 as shown in FIGS. 5 and 6 is controlled by a scanning line SL, the source electrode of the fourth transistor Tr4 may be set at a negative potential Vee lower than that at the cathode of the organic light emitting diode OLED.

Fifth Embodiment

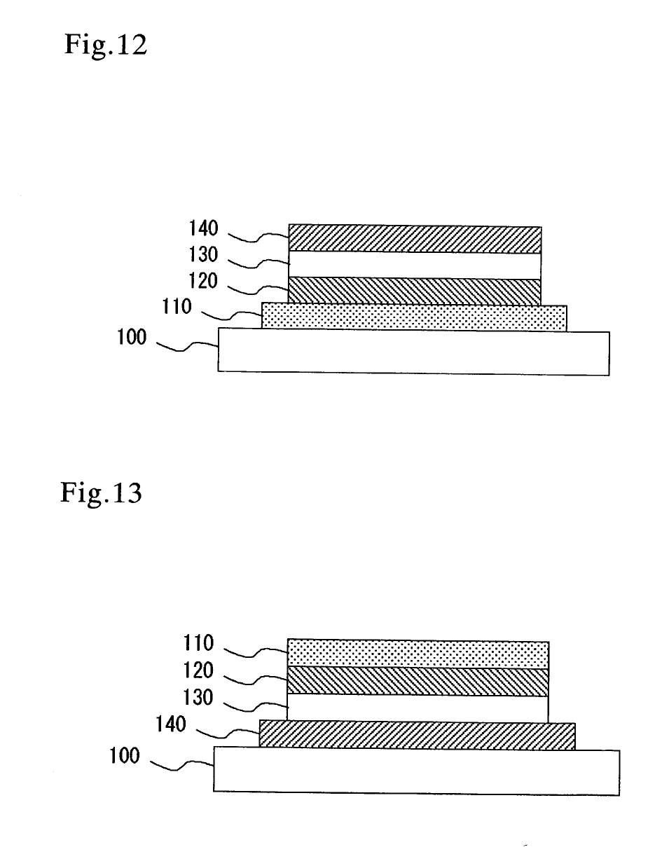

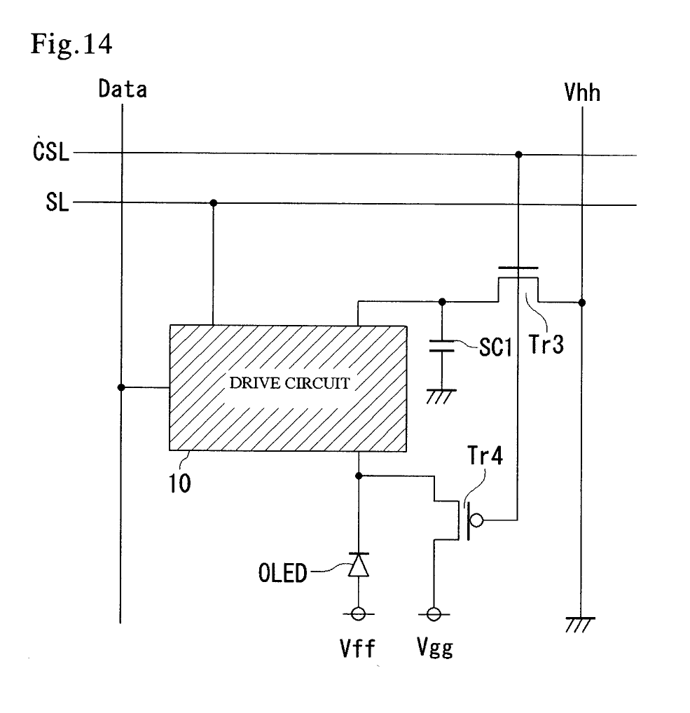

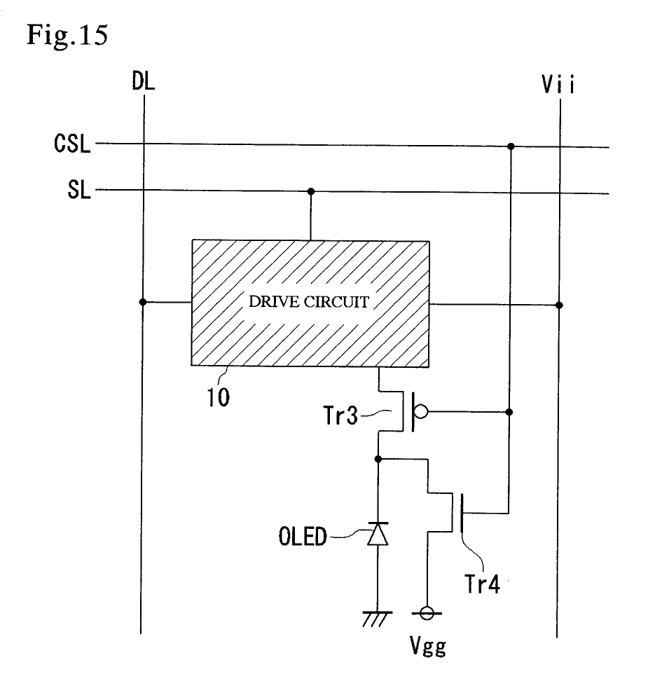

In general, a multi-layer structure of an organic light emitting diode OLED is such that an anode layer 110, a hole transporting layer 120, an organic EL layer 130 and a cathode layer 140 are stacked, in this order from the bottom to the top thereof, on an insulating substrate such as a glass substrate 100, as shown in FIG. 12. The multi-layer structure of an organic light emitting diode OLED is not limited to that shown in FIG. 12, and may be such that a cathode layer 140, an organic EL layer 130, a hole transporting layer 120 and an anode layer 110 are stacked, in this order from the bottom to the top thereof, on the insulating substrate such as the glass substrate 100, as shown in FIG. 13. If the multi-layer structure of the organic light emitting diode OLED is one as shown in FIG. 12, a cathode of the organic light emitting diode OLED is connected to ground potential which is fixed potential. If the multi-layer structure of the organic light emitting diode OLED is one as shown in FIG. 13, an anode of the organic light emitting diode OLED is connected the fixed potential. FIGS. 14 and 15 are examples of pixel circuits suitable for the organic light emitting diodes OLEDs having such structures shown in FIGS. 12 and 13, respectively.

FIG. 14 is a circuit for a pixel where the anode and the cathode of the organic light emitting diode OLED shown in the pixel circuit of FIG. 10 are replaced with the cathode and the anode thereof, respectively, so that an anode of an organic light emitting diode OLED shown in FIG. 14 is connected to a power supply potential Vff which is both a positive potential and a fixed potential. Moreover, an electrode connected,to the negative potential Vee of the fourth transistor Tr4 in FIG. 10 is now connected to a positive potential Vgg which is higher than the power supply potential Vff. An electrode of the third transistor Tr3 connected to a power supply line Vdd in FIG. 10 is now connected to a low potential line Vhh which is ground potential.

Moreover, the third transistor Tr3 becomes now an n-channel transistor instead of the p-channel transistor while the fourth transistor Tr4 becomes a p-channel transistor instead of the n-channel transistor. During a luminescence period of the organic light emitting diode, the current flows to the low potential line Vhh which is ground potential by way of the organic light emitting diode OLED, drive circuit 10 and third transistor Tr3. Then, turning high on a control line CSL turns the third transistor Tr3 on and the fourth transistor Tr4 off. When the control line CSL turns low during a luminance data updating period of the organic light emitting diode OLED, the third transistor Tr3 turns off and the fourth transistor Tr4 turns on. Thus, a potential at the cathode of the organic light emitting diode OLED becomes a positive potential Vgg which is a potential higher than the power supply potential Vff, so that the organic light emitting diode OLED becomes a state of a reverse bias being applied.

FIG. 15 shows a circuit for a pixel where the anode and the cathode of the organic light emitting diode OLED shown in the pixel circuit of FIG. 10 are replaced with the cathode and the anode thereof, respectively, so that an anode of an organic light emitting diode OLED shown in FIG. 15 is connected to ground potential. The power supply line Vdd, connected to the drive circuit 10, which is a positive potential in FIG. 11 is now in FIG. 15 a negative potential line Vii which is a negative potential. Moreover, an electrode connected to the positive potential Vee of the fourth transistor Tr4 in FIG. 11 is now connected to a positive potential Vgg which is higher than ground potential. When the control line CSL turns high during a luminance data updating period of the organic light emitting diode OLED, the fourth transistor Tr4 turns on and the third transistor Tr3 turns off. Then, a potential at the cathode of the organic light emitting diode OLED becomes a positive potential Vgg which is a potential higher than the power supply potential Vff which is a potential at the anode thereof, so that the organic light emitting diode OLED becomes a state of a reverse bias being applied.

In the pixel circuits shown in FIGS. 14 and 15, the third transistor Tr3 and the fourth transistor Tr4 are on-off controlled by the control line CSL, but these are not limited thereto and the circuit may be structured such that it is on-off controlled by a scanning line SL. In that case, it suffices that there is provided a transistor in which the third transistor Tr3 turns off and the fourth transistor Tr4 turns on when luminance data is set in the drive circuit 10.

In the following preferred embodiments, an active matrix organic EL display is assumed as a display apparatus. In these embodiments, a novel circuitry is proposed where the electric charge in the optical element, which is the cause of the above-described residual image phenomenon, is discharged and a potential difference across the optical element is reduced to a level where there occurs practically no residual image phenomenon. To be provided for this purpose is a switching element that separates source voltage from the optical element.

Sixth Embodiment

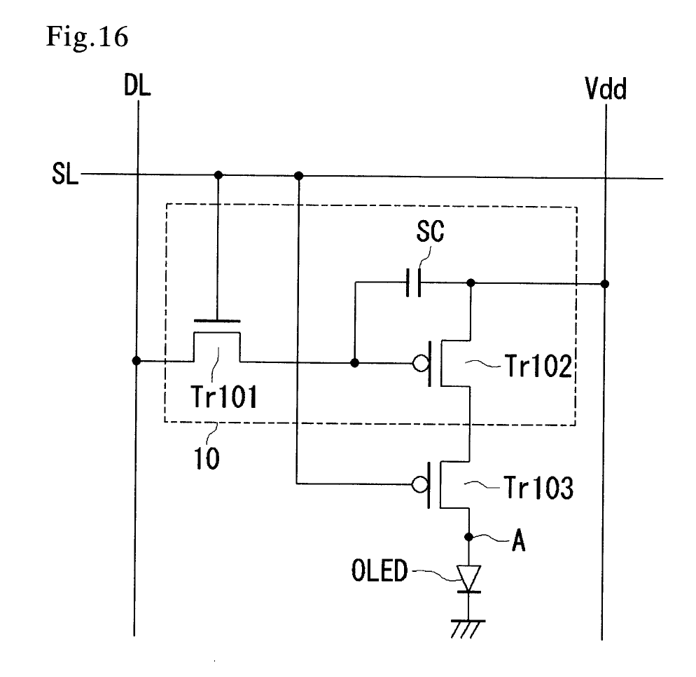

FIG. 16 shows a circuit for a pixel of a display apparatus according to a sixth embodiment of the present invention. The pixel is comprised of an organic light emitting diode OLED which is an optical element, a first transistor Tr101 and a third transistor Tr103 which function as switching elements, a second transistor Tr102 which is a driving transistor where luminance data is set, a storage capacitance SC, and a scanning line SL which turns on and off each of the first and third transistors Tr101 and Tr103. Moreover, the first transistor Tr101 is an n-channel transistor whereas the second and third transistors Tr102 and Tr103 are p-channel transistors. The pixel is further comprised of a data line DL to which the luminance data is inputted, and a power supply line Vdd which supplies current to the organic light emitting diode OLED. The scanning line SL, the data line DL and the power supply line Vdd are shared by the other pixels. In particular, part of a circuit comprised of the first and second transistors Tr101 and Tr102 and the storage capacitance SC is called a drive circuit 10.

A gate electrode of the first transistor Tr101 is connected to the scanning line SL whereas a drain electrode (or a source electrode) of the first transistor Tr101 is connected to the data line DL. The source electrode (or the drain electrode) of the first transistor Tr101 and a gate electrode of the second transistor Tr102 are connected to one of the electrodes of the storage capacitance SC. A source electrode of the second transistor Tr102 and the other electrode of the storage capacitance SC are connected to the power supply line Vdd, and a drain electrode of the second transistor Tr102 is connected to a source electrode of the third transistor Tr103. A drain electrode of the third transistor Tr103 and the anode of the organic light emitting diode OLED are connected at a node A. Moreover, a cathode of the organic light emitting diode OLED is connected to ground potential. Accordingly, the second transistor Tr102, the third transistor Tr103 and the organic light emitting diode OLED, in this order, are connected in series from the power supply line Vdd to grounding voltage, thus forming a path for the luminescence of the optical element (hereinafter referred to simply as a main path also).

An operation of a circuit configured as above will be described hereinbelow. When the scanning line SL turns high to write luminance data, the first transistor Tr101 turns on and the third transistor Tr103 turns off, so that a data voltage corresponding to the luminance data is supplied from the data line DL, and the luminance data is set at the storage capacitance SC and the gate electrode of the second transistor Tr102. Here, since the organic light emitting diode OLED is shut off from the power supply line Vdd by the third transistor Tr103, the potential difference across the organic light emitting diode OLED drops to a voltage which is determined by length of time during which the path is shut off, a time constant of the organic light emitting diode OLED and a potential difference immediately before the shutoff. The potential at the node A at this time is permissible as long as it is at a level that does not adversely affect the image display.

Then, as the scanning line SL turns low upon completion of writing of the luminance data, the first transistor Tr101 turns off and the third transistor Tr103 turns on. Then, a current corresponding to a voltage set in the gate electrode of the second transistor Tr102 and the storage capacitance SC flows to the organic light emitting diode OLED.

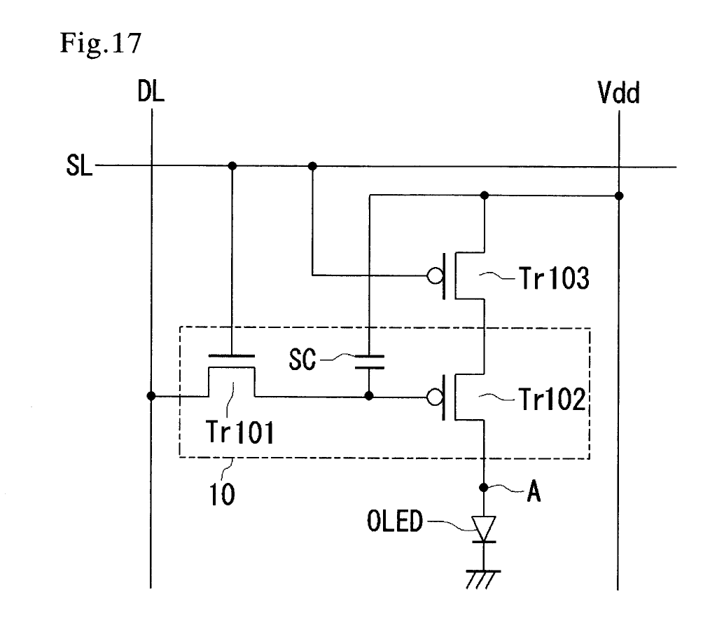

As exemplified by a circuit shown in FIG. 17, it may be so arranged that the third transistor Tr103 and the second transistor Tr102 are replaced with each other in the order of connection, the third transistor Tr103 is provided on a power supply line Vdd side, and the third and second transistors Tr103 and Tr102 and the organic light emitting diode OLED are connected in this order from power supply line Vdd to ground potential. The description of the operation of this circuit is omitted because the operation thereof is similar to that of the circuit shown in FIG. 16.

According to the sixth embodiment, therefore, the potential at the node A drops as described above, so that the residual image phenomenon, which is seen when a small luminance data is set in a pixel where a large luminance data is already set, can be eliminated. Moreover, power consumption is reduced because the main path is cut off from the power supply line Vdd during the writing of luminance data. Moreover, the gate voltage at the second transistor Tr102 is stabilized because the storage capacitance SC is provided between the gate electrode of the second transistor Tr102 and the power supply line Vdd.

Seventh Embodiment

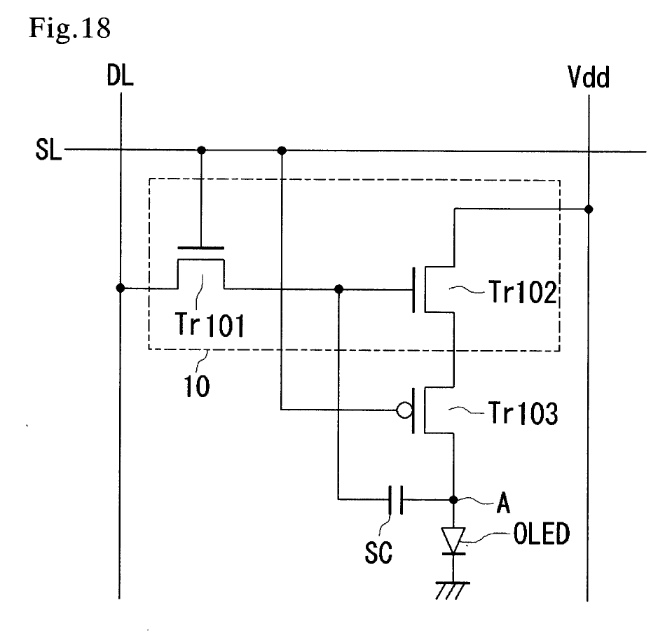

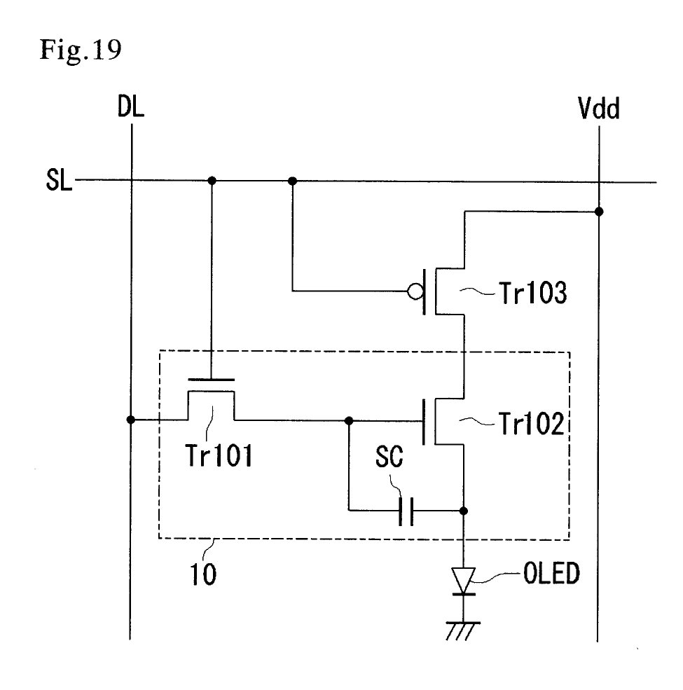

In the circuit shown with reference to the sixth embodiment, the second transistor Tr102, which is a driving transistor, is a p-channel transistor, whereas in a seventh embodiment, an n-channel transistor is utilized. Since the circuit according to the seventh embodiment is generally identical to the circuit according to the sixth embodiment, only different portions thereof will be described hereinbelow. FIG. 18 shows a circuit where the order of connection in the main path from a power supply line Vdd to ground voltage is a second transistor Tr102, a third transistor Tr103 and an organic light emitting diode OLED, and FIG. 19 shows a circuit where the order of connection therein is a third transistor Tr103, a second transistor Tr102 and an organic light emitting diode OLED. Thus, FIGS. 18 and 19 show the circuits of FIGS. 16 and 17, respectively, in which the second transistor Tr102 is replaced by an n-channel transistor. It is to be noted, however, that in both circuits of FIGS. 18 and 19, the storage capacitance SC is connected between the gate electrode of the second transistor Tr102 and the anode of the organic light emitting diode OLED.

Operations by the circuits configured as in FIGS. 18 and 19 will be described hereinbelow. When the scanning line SL turns high to write luminance data, the first transistor Tr101 turns on and the third transistor Tr103 turns off, thereby a data voltage corresponding to the luminance data is supplied from the data line DL, and the luminance data is set at the storage capacitance SC and the gate electrode of the second transistor Tr102. Here, similar to the sixth embodiment, since the organic light emitting diode OLED is cut off from the power supply line Vdd by the third transistor Tr103, the potential difference across the organic light emitting diode OLTD drops to a voltage which is determined by length of time during which the path is shut off, a time constant of the organic light emitting diode OLED and a potential difference immediately before the shutoff. The potential at the node A at this time is permissible as long as it is at a level that does not adversely affect the image display.

Then, as the scanning line SL turns low upon completion of writing of the luminance data, the first transistor Tr101 turns off and the third transistor Tr103 turns on. Then, a current corresponding to a voltage set in the gate electrode of the second transistor Tr102 and the storage capacitance SC flows to the organic light emitting diode OLED.

At this time, the potential at the node A rises, but the electric charge stored in the storage capacitance SC is maintained, so that the potential at the gate electrode of the second transistor Tr102 rises, too, as much as the potential rise at the node A. Accordingly, a desired gate voltage is maintained, and there occurs no change in the value of current that flows to the organic light emitting diode OLED. Moreover, even when the potential at the node A changes under certain circumstances, the electric charge in the storage capacitance SC is maintained as mentioned above and therefore the potential difference across the storage capacitance SC, namely, the gate voltage of the second transistor Tr102, will be subjected to no influence thereof. Furthermore, there is no need for-preparing a separate wiring for the storage capacitance SC.

According to the seventh embodiment, the same advantageous effects as in the sixth embodiment are obtained.

The present invention has been described based on embodiments which are only exemplary. It is understood by those skilled in the art that there exist other various modifications to the combination of each component and each processing described and that such modifications are encompassed by the scope of the present invention. Such modifications will be described hereinbelow.

In the preferred embodiments, the third transistor Tr103, which is provided in the main path to function as a switching element, is a p-channel transistor, but it is not limited thereto and may be an n-channel transistor as well. In such a case, however, the third transistor Tr103 must be turned off when turning the scanning line SL high, which requires provision of a separate scanning line and setting it to have an inverted activity of the scanning line SL as described in the embodiments.

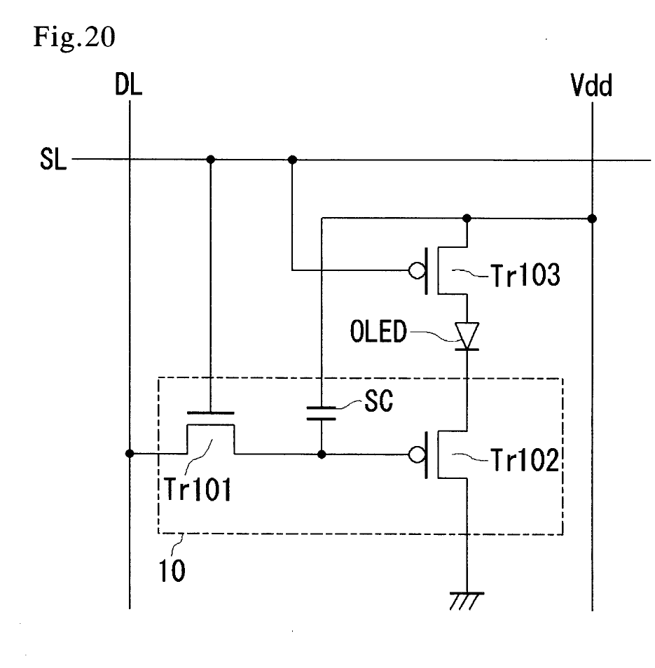

In the above embodiments, the driving transistor is provided on the power supply line Vdd side of the organic light emitting diode OLED, which is an optical element, but, as in a circuit shown in FIG. 20, the organic light emitting diode OLED may be provided on the power supply line Vdd side instead.

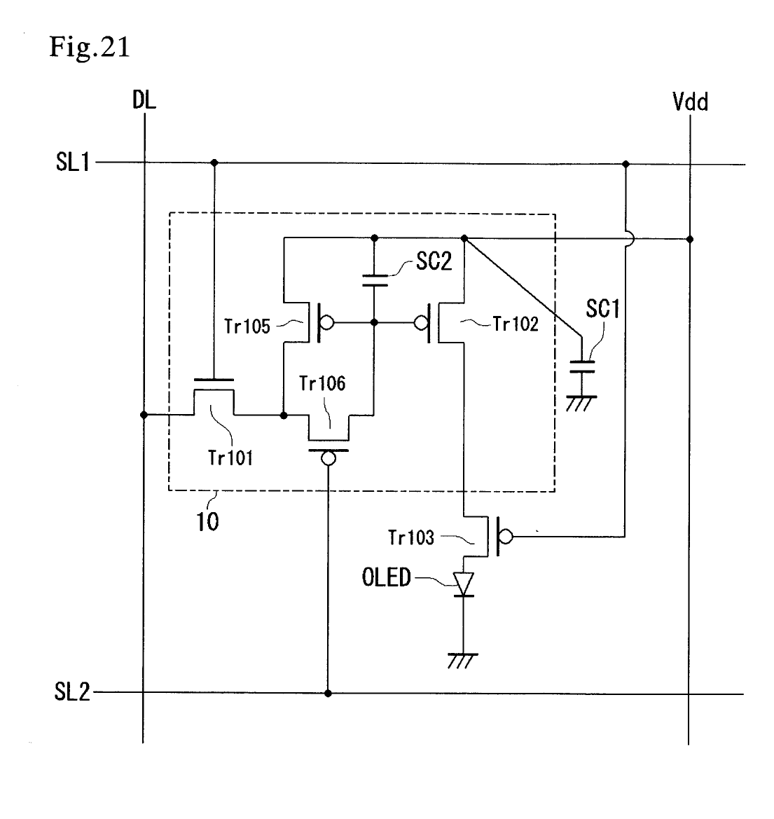

FIG. 21 shows a modified example for the circuit for a pixel of the above-described display apparatus, and shows a pixel circuit where the drive circuit 10 is modified. This pixel shown in FIG. 21 is comprised of an organic light emitting diode OLED serving as an optical element, a drive circuit 10, first and second storage capacitances SC1 and SC2, a third transistor Tr103 which functions as a switching element, a data line DL, a power supply line Vdd and first and second scanning lines SL1 and SL2. The drive circuit 10 is further comprised of first, second, fifth and sixth transistors Tr101, Tr102, Tr105 and Tr106. The first and second transistors Tr101 and Tr102 are an n-channel transistors, whereas the third, fifth and sixth transistors Tr103, Tr105 and Tr106 are p-channel transistors. The first scanning line SL1 is a signal line to which a signal for updating luminance data is applied when setting luminance data of the organic light emitting diode OLED in this pixel circuit. The first scanning line SL is provided in a manner such that it is shared by pixels of the same row. The second scanning line SL2 is a scanning line which is provided in a manner such that it is shared by pixels of the next row.

Gate electrodes of the first and third transistors Tr101 and Tr103 are connected to the first scanning line SL1, and a gate electrode of the sixth transistor Tr106 is connected to the second scanning line SL2. A drain electrode (or a source electrode) of the first transistor Tr101 is connected to the data line DL. The source electrode (or the drain electrode) of the first transistor Tr101 and a drain electrode of the fifth transistor Tr105 are connected to a drain electrode (or a source electrode) of the sixth transistor Tr106. Gate electrodes of the second and fifth transistors Tr102 and Tr105 and the source electrode (or the drain electrode) of the sixth transistor Tr106 are one of two electrodes of the second storage capacitance SC2. Source electrodes of the second and fifth transistors Tr102 and Tr105, a drain electrode of the third transistor Tr103 and the other electrode of the second storage capacitance SC2 are connected to one of two electrodes of the first storage capacitance SC1. The source electrode of the third transistor Tr103 is connected to the power supply line Vdd, and the other electrode of the first storage capacitance SC1 is connected to ground potential. A drain electrode of the second transistor Tr102 is connected to an anode of the organic light emitting diode OLED at a node A. A cathode of the organic light emitting diode OLED is connected to ground potential.

An operation of this circuit will be described hereinbelow. When the first scanning line SL1 turns high and the second scanning line SL2 turns low to write luminance data, the first and sixth transistors Tr101 and Tr106 turn on and the third transistor Tr103 turns off. The gate electrode and drain electrode of the fifth transistor Tr105 are short-circuited and the fifth transistor Tr105 operates within an unsaturated domain, so that potential at the gate electrode of the fifth transistor Tr105 becomes the same as potential at the gate electrode of the second transistor Tr102. Thus, the luminance data is set in the second transistor Tr102. Then, since a path from the power supply line Vdd is shut off as a result of the third transistor Tr103 having been off, the potential difference across the organic light emitting diode OLED drops to a voltage which is determined by length of time during which the path is shut off, a time constant of the organic light emitting diode OLED and a potential difference immediately before the shutoff. The electric charge at the anode and potential of the anode of the organic light emitting diode drop to ground potential. The potential at the node A at this time is permissible as long as it is at a level that does not adversely affect the image display.

At the timing of luminescence, the first scanning line SL1 turns low and the second scanning line SL2 turns high whereas the first, fourth and sixth transistors Tr101, Tr104 and Tr106 turns off and the third transistor Tr103 turns on. Thereby, a current corresponding to the luminance data set in the second transistor Tr102 flows to the organic light emitting diode OLED.

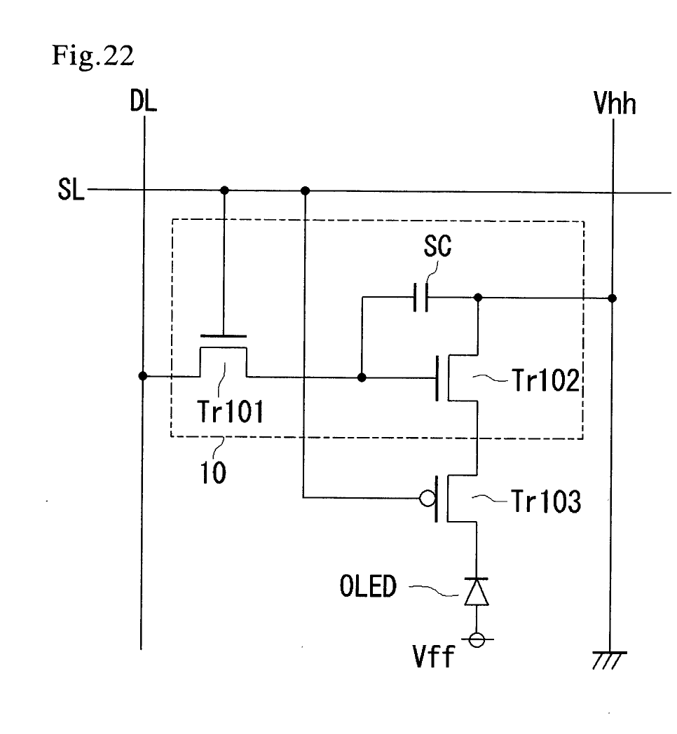

FIG. 22 is a pixel circuit which is modified based on that shown in FIG. 16 where the multi-layer structure of the organic light emitting diode OLED shown in FIG. 16 is reversed in the similar manner shown in FIG. 13 against a general type of the regular multi-layer structure shown in FIG. 12. In this pixel circuit of FIG. 22, the anode and cathode of the organic light emitting diode OLED shown in FIG. 16 are replaced with the cathode and anode thereof, respectively. Thus, the anode of the organic light emitting diode OLED is connected to a power supply potential Vff which is positive potential and fixed potential. The power supply line Vdd, once connected to the source electrode of the second transistor Tr102 in FIG. 16, which is positive potential is now connected to a low potential line Vhh which is ground potential. It is to be noted here that the pixel circuit may be structured such that the anode of the organic light emitting diode OLED is connected to ground potential and the source electrode of the second transistor Tr102 is connected to a negative potential line which is negative potential.

In the following embodiments, an active matrix organic EL display is again assumed as a display apparatus. In these embodiments, novel circuitry that can reduce the residual image phenomenon will be proposed.

Eighth Embodiment

According to an eighth embodiment, prior to the setting of luminance data to a drive element, a gate voltage at a drive element is changed to a value that will put the optical element in the off state by setting a zero or a sufficiently low value, in advance, as dummy luminance data. In setting the dummy luminance data, a scanning signal for a pixel controlled preceding the intended pixel is used. Thus, electric charge remaining in the optical element is eliminated since the optical element turns off once when the optical element is shut off from power supply immediately before the luminance data is set in the drive element.

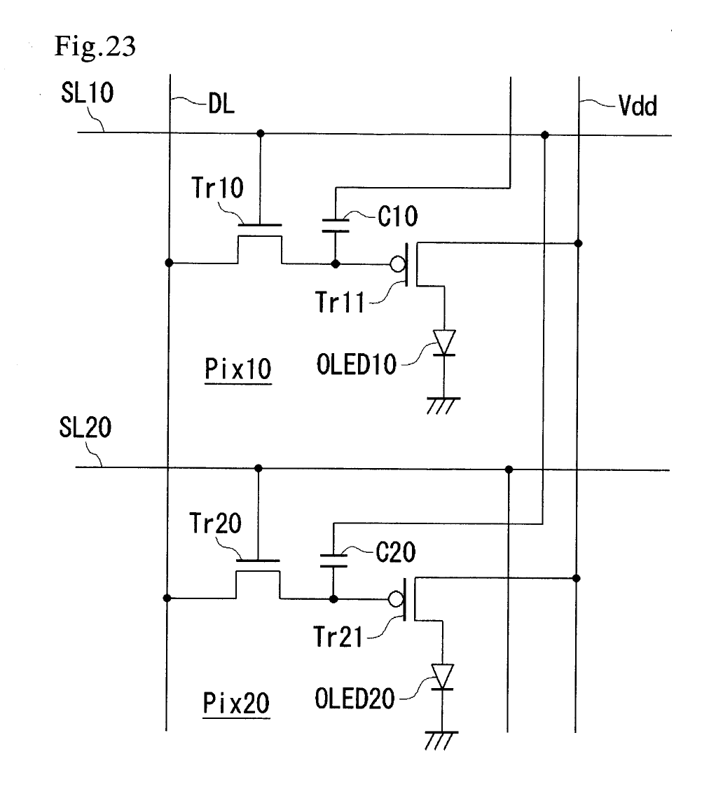

FIG. 23 shows a circuit structure for two pixels of a display apparatus according to the eighth embodiment. A first pixel Pix10 and a second pixel Pix20 are each a circuit for one pixel. The first pixel Pix10 includes a first transistor Tr10 which serves as a switching element, a second transistor Tr11 which serves as a drive element, a first capacitor C10 which serves as a storage capacitance, and a first organic light emitting diode OLED10 which serves as an optical element. Similarly, the second pixel Pix20 includes a third transistor Tr20 which serves a switching element, a fourth transistor Tr21 which serves as a drive element, a second capacitor C20 which serves as a storage capacitance, and a second organic light emitting diode OLED20 which serves as an optical element.

A power supply line Vdd supplies voltage that causes to emit light of the first and second organic light emitting diodes OLED10 and OLED20. A data line DL sends signals for luminance data to be set in the second transistor Tr11 and the fourth transistor Tr21. A first scanning line SL10 and a second scanning line SL20 send scanning signals that activate the first transistor Tr10 and the third transistor Tr20 at the timing that causes to emit light of the first and second organic light emitting diodes OLED10 and OLED20, respectively. According to this eighth embodiment, the first transistor Tr10 is first activated followed by activation of the third transistor Tr20.

The first transistor Tr10 is an n-channel transistor. A gate electrode of the first transistor Tr10 is connected to the scanning line SL10, a source electrode (or a drain electrode) of the first transistor Tr10 is connected to the data line DL, and the drain electrode (or the source electrode) of the first transistor Tr10 is connected to a gate electrode of the second transistor Tr11. The third transistor Tr20 is also an n-channel transistor, and a gate electrode of the third transistor Tr20 is connected to the scanning line SL20, a source electrode (or a drain electrode) of the third transistor Tr20 is connected to the data line DL, and the drain electrode (or the source electrode) of the third transistor Tr20 is connected to a gate electrode of the fourth transistor Tr21.

The second transistor Tr11 is a p-channel transistor, and a source electrode of the second transistor Tr11 is connected to the power supply line Vdd and a drain electrode of the second transistor Tr11 is connected to an anode electrode of the first organic light emitting diode OLED10. The fourth transistor Tr21 is also a p-channel transistor, and a source electrode of the fourth transistor Tr21 is connected to the power supply line Vdd and a drain electrode of the fourth transistor Tr21 is connected to an anode electrode of the second organic light emitting diode OLED20. The potential at the cathode electrodes of the first and second organic light emitting diodes OLED10 and OLED20 is equal to the ground potential.

One end of the first capacitor C10 is connected to a path between the drain electrode (or the source electrode) of the first transistor Tr10 and the gate electrode of the second transistor Tr11, whereas the other end of the first capacitor C10 is connected to a scanning line, not shown here, which sends a scanning signal to a pixel controlled immediately before this pixel Pix10. One end of the second capacitor C20 is connected to a path between the drain electrode (or the source electrode) of the third transistor Tr20 and the gate electrode of the fourth transistor Tr21, whereas the other end of the second capacitor C20 is connected to the first scanning line SL10 which sends a scanning signal to the first pixel Pix10.

An operation of the circuit with a structure as described above will be explained hereinbelow, taking the second pixel Pix20 as an example.

First, as the scanning signal at the second scanning line SL20 turns high, the third transistor Tr20 turns on. Thereafter, as luminance data of negative logic to be set in the fourth transistor Tr21 flows to the data line DL, the potential of the-luminance data flowing to the data line DL becomes equal to the gate potential of the fourth transistor Tr21 since the third transistor Tr20 has become on. As a result thereof, the luminance data is set. A current corresponding to a gate-source voltage, which is a voltage between a gate and a source, at the fourth transistor Tr21 flows from the power supply line Vdd to a drain electrode side, and the second organic light emitting diode OLED20 emits light according to an amount of the current. Even when the scanning signal at the second scanning line SL20 turns to a low state and the third transistor Tr20 turns off, the luminance data remains stored with a floating state between the drain electrode (or the source electrode) of the third transistor Tr20 and the gate electrode of the fourth transistor Tr21, so that a luminescence of the second organic light emitting diode OLED20 corresponding to the luminance data is maintained.

At a next scanning timing, when a scanning signal to the first pixel Pix10 to be controlled immediately prior to the second pixel Pix 20 goes high, there is a floating between the gate electrode of the fourth transistor Tr21 and the drain electrode (or the source electrode) of the third transistor Tr20, so that the potential at the gate electrode of the fourth transistor Tr21 is pushed up. As a result thereof, the same condition is created as when dummy luminance data is set to make the gate-source voltage at the fourth transistor Tr21 smaller. The second organic light emitting diode OLED20, which is cut off from the power supply line Vdd, goes out.

As the scanning signal at the first scanning line SL10 goes low, the potential at one end on the first scanning line SL10 side of the second capacitor C20 drops. And almost simultaneously, the second scanning line SL20 goes high and the third transistor Tr20 turns on, so that the luminance data from the data line DL is set in the gate electrode of the fourth transistor Tr21. Immediately before this setting of luminance data, the second organic light emitting diode OLED20 is turned off, so that the electric charge remaining in the optical element can be eliminated.

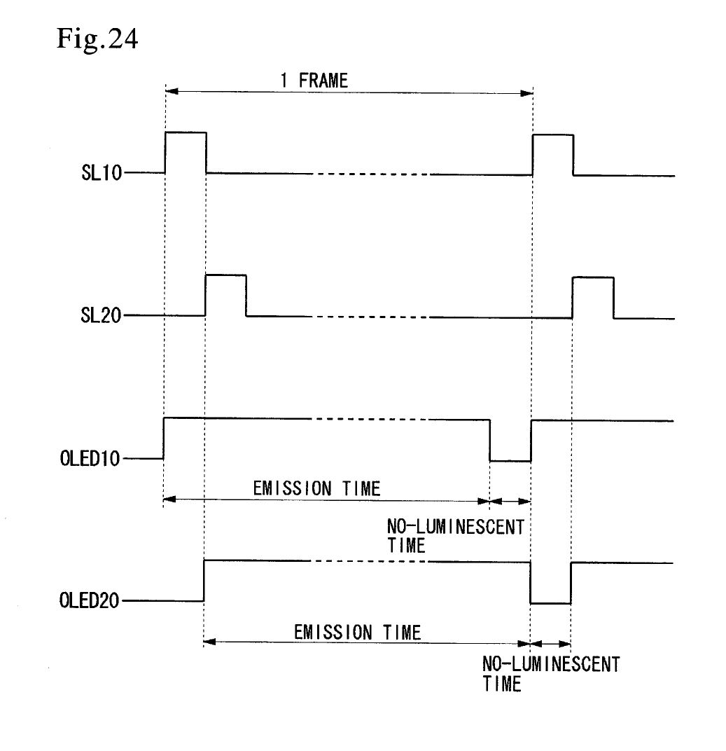

FIG. 24 is a timing chart showing relationships between the states of scanning signals and the emission time and non-luminescent time in a display apparatus according to the eighth embodiment of the present invention. In FIG. 24, the states of scanning signals at the first scanning line SL10 and the second scanning line SL20 are shown by high and low levels. While the first and second organic light emitting diodes OLED10 and OLED20 emit light at intensity corresponding to the luminance data, the emission time and the non-luminescent time are simply shown by a high level and a low level, respectively, in FIG. 24.

As the scanning signal at the first scanning line SL10 goes high, the first organic light emitting diode OLED10 emits light and the state of luminescence is maintained even when the scanning signal goes low. Similarly, as the scanning signal at the second scanning line SL20 goes high, the second organic light emitting diode OLED20 emits light and the state of luminescence is maintained even when the scanning signal goes low. At the end of scanning for one frame, when the scanning signal goes high at a scanning line (not shown) scanned immediately before the first scanning line SL10, the first organic light emitting diode OLED10 goes out and then emits light again simultaneously when the first scanning line SL10 goes high. Similarly, as the first scanning line SL10 goes high, the second organic light emitting diode OLED20 goes out and then emits light again simultaneously when the second scanning line SL20 goes high.

In this manner, most of the duration of scanning for one frame is the luminescent time, but the luminescence turns off only during the time for a single scanning immediately before the next scanning signal goes high.

Ninth Embodiment

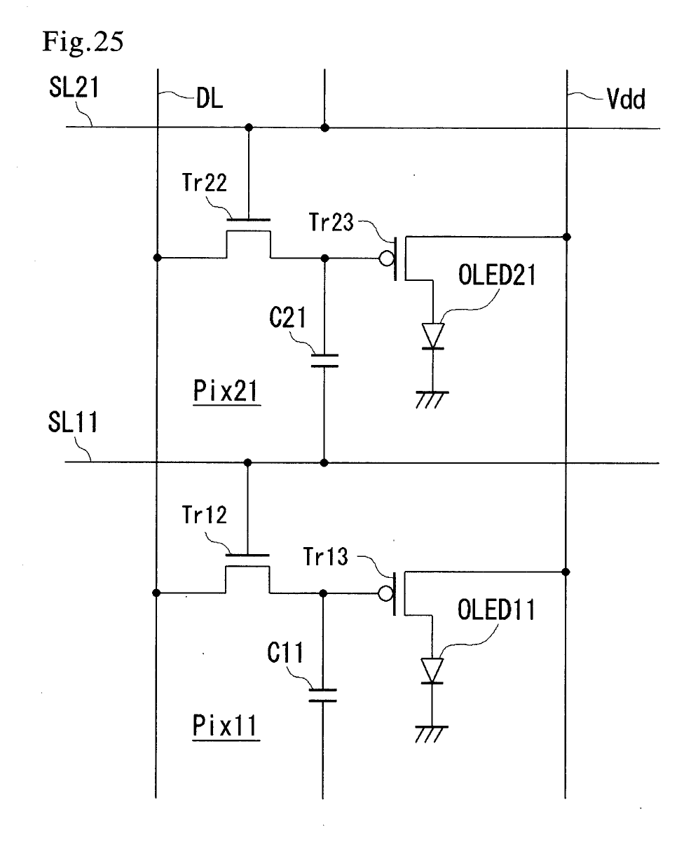

FIG. 25 shows a circuit structure for one pixel of a display apparatus according to a ninth embodiment. In the circuit shown in FIG. 25, the respective elements are arranged in a different pattern from the circuit shown in FIG. 23, but the structure and operation of the circuit are substantially the same as those of the circuit according to the eighth embodiment. In FIG. 23, scanning is performed in the order of the first pixel Pix10 and the second pixel Pix20, namely, from above to below in the figure. In FIG. 25, however, scanning is performed in the order of the first pixel Pix11 and the second pixel Pix21, namely, from below to above in the figure. One end of the second capacitor C21 of the second pixel Pix21 is connected to the first scanning line SL11 for which a scanning signal goes high previously, whereas one end of the first capacitor C11 of the first pixel Pix11 is connected to a scanning line (not shown) for which a scanning signal goes high previously.

Tenth Embodiment

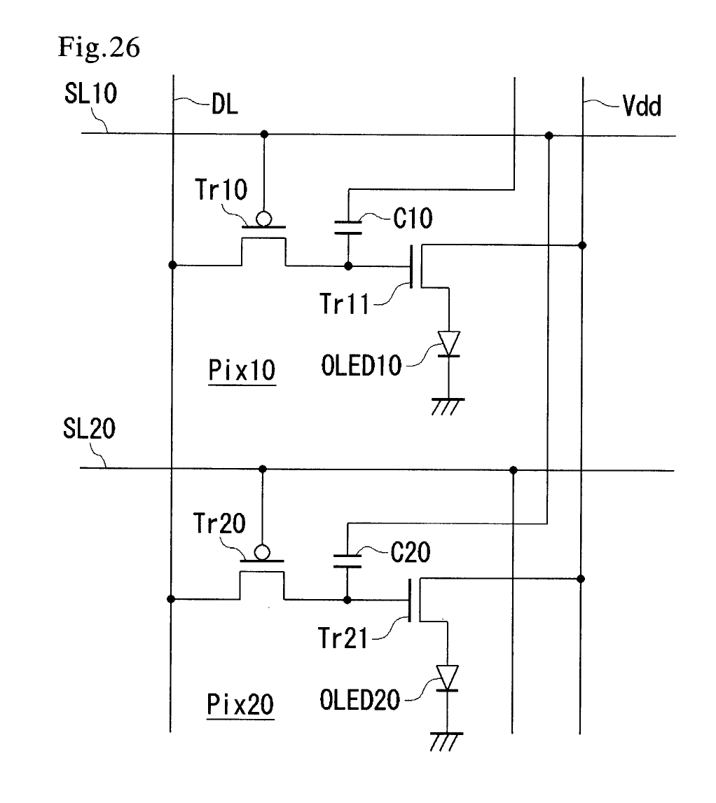

FIG. 26 shows a circuit structure for two pixels of a display apparatus according to a tenth embodiment. This tenth embodiment differs from the eighth and ninth embodiments in the transistors used in the display apparatus. Namely, in the eighth and ninth embodiments, n-channel transistors are used as the first and third transistors Tr10 and Tr20 and p-channel transistors as the second and fourth transistors Tr11 and Tr21, but, in this tenth embodiment, p-channel transistors are used as the first and third transistors Tr10 and Tr20 and n-channel transistors as the second and fourth transistors Tr11 and Tr21.

In this case, the signal of luminance data flowing to a data line DL is of positive logic, whereas a scanning signal flowing to first and second scanning lines SL10 and SL20 is a negative logic pulse. As the scanning signal at the second scanning line SL20 goes low, luminance data of positive logic flows from the data line DL and is set in the fourth transistor Tr21, thereby a current corresponding to the luminance data flows to a second organic light emitting diode OLED20 so as to emit light. As the scanning signal at the second scanning line SL20 goes high, the third transistor Tr20 turns off, thereby the luminance data is held at a gate electrode of the fourth transistor Tr21.

As the scanning signal at the first scanning line SL10 goes low, a floating gate potential at the fourth transistor Tr21 is pulled down via a second capacitor C20, and a gate-source voltage at the fourth transistor Tr21, which is thus reduced, causes the second organic light emitting diode OLED20 to turn off. As the scanning signal at the second scanning line SL20 goes low, the third transistor Tr20 turns on, so that the luminance data is set in the fourth transistor Tr21, thus causing the second organic light emitting diode OLED20 to emit light again.

Eleventh Embodiment

This eleventh embodiment differs from the eighth to tenth embodiments in the transistors used in the display apparatus. Namely, this eleventh embodiment differs from the other embodiments in that n-channel transistors are used as all the first to fourth transistors Tr10, Tr11, Tr20 and Tr21. In this case, an inverted scanning signal is applied to one end on a scanning line side of the first and second capacitors C10 and C20, which drops the gate-source voltage at the second and fourth transistors Tr11 and Tr21 and thus causes the first and second organic light emitting diodes OLED10 and OLED20 to turn off.

Twelfth Embodiment

This twelfth embodiment differs from the seventh to eleventh embodiments in the transistors used in the display apparatus. Namely, this twelfth embodiment differs from the other embodiments in that p-channel transistors are used as all the first to fourth transistors Tr10, Tr11, Tr20 and Tr21. In this case, too, an inverted scanning signal is applied to one end on the scanning line side of the first and second capacitors C10 and C20, which drops the gate-source voltage at the second and fourth transistors Tr11 and Tr21 and thus causes the first and second organic light emitting diodes OLED10 and OLED20 to turn off.

Thirteenth Embodiment

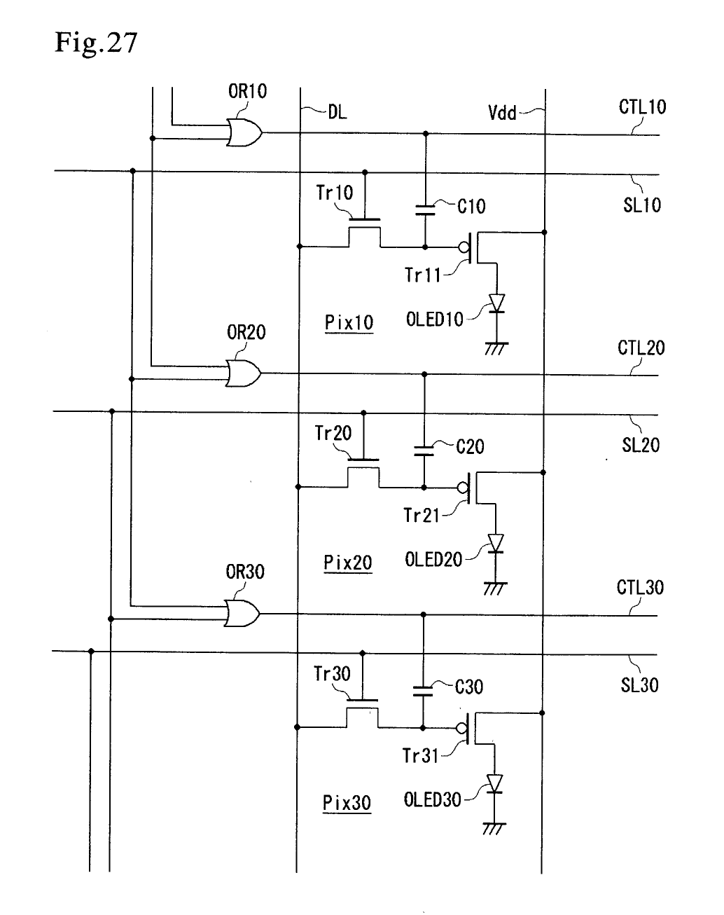

In the eighth to twelfth embodiments, a scanning signal is utilized to set dummy luminance data in the drive element, but this thirteenth embodiment differs therefrom in that separate control signals are utilized for that purpose. FIG. 27 shows a circuit structure for three pixels of a display apparatus according to a thirteenth embodiment. Each of the first to third pixels Pix10, Pix20 and Pix30 is comprised of one circuit for a single pixel. First to sixth transistors Tr10, Tr11, Tr20, Tr21, Tr30 and Tr31, first to third capacitors C10, C20 and C30, and first to third organic light emitting diodes OLED10, OLED20 and OLED30 are of the structure similar to the corresponding elements in the seventh embodiment. Control signals are sent to the first to third pixels Pix10, Pix20 and Pix30 via first to third control signal lines CTL10, CTL20 and CTL30, respectively. These control signals are outputted from first to third OR circuits OR10, OR20 and OR30, respectively.

The third pixel Pix30 is taken as an example in the following description. A gate electrode of the fifth transistor Tr30 is connected to a third scanning line SL30, a source electrode (or a drain electrode) of the fifth transistor Tr30 is connected to a data line DL, and the drain electrode (or the source electrode) of the fifth transistor Tr30 is connected to a gate electrode of the sixth transistor Tr31. A source electrode of the sixth transistor Tr31 is connected to a power supply line Vdd, and a drain electrode of the sixth transistor Tr31 is connected to an anode electrode of the third organic light emitting diode OLED30. The potential at a cathode electrode of the third organic light emitting diode OLED30 is made equal to ground potential. One end of the third capacitor C30 is connected to the third control signal line CTL30, and the other end of the third capacitor C30 is connected to a path between the drain electrode (or the source electrode) of the fifth transistor Tr30 and the gate electrode of the sixth transistor Tr31.

The third control signal line CTL30 is connected to a second scanning line SL20, which sends a scanning signal to the pixel Pix20 that is the pixel to be controlled one step previously, and a first scanning line SL10, which sends a scanning signal to the pixel Pix10 that is the pixel to be controlled two steps previously. In other words, the control signal for the third control signal line CTL30 is outputted from the third OR circuit OR30 in the form of a logical OR of the scanning signal of the first scanning line SL10 and the scanning signal of the second scanning line SL20.

As the scanning signal at the third scanning line SL30 goes high, the fifth transistor Tr30 turns on and luminance data of negative logic that flows to the data line DL is set in the gate electrode of the sixth transistor Tr31. This causes the third organic light emitting diode OLED30 to emit light. Even when the scanning signal at the third scanning line SL30 goes low and the fifth transistor Tr30 turns off, the luminance data is held on a gate electrode side of the sixth transistor Tr31, so that an emission state of the third organic light emitting diode OLED30 is maintained.

As either of the scanning signals at the first scanning line SL10 and the second scanning line SL20 is set high, the control signal at the third control signal line CTL30 is also set high by the third OR circuit OR30. This pushes up the gate potential at the sixth transistor Tr31 and makes the gate-source voltage at the sixth transistor Tr31 smaller, thereby the sixth transistor Tr31 turns off, thus causing the third organic light emitting diode OLED30 to go out. Namely, the gate potential at the sixth transistor Tr31 remains pushed up all the while a pixel line two steps before is being scanned and a pixel line one step before is being scanned, so that the third organic light emitting diode OLED30 turns off. The control signal at the third control signal line CTL30 goes low when both the scanning signal at the first scanning line SL10 and the scanning signal at the second scanning line SL20 go low. As the scanning signal at the third scanning line SL30 goes high, the fifth transistor Tr30 turns on, thereby luminance data is set in the gate electrode of the sixth transistor Tr31 and the third organic light emitting diode OLED30 turns on again.

According to the present embodiment, too, electric charge remaining in the optical element can be eliminated by turning off the optical element by shutting it off from power supply.

The present invention has been described based on embodiments which are only exemplary. It is understood by those skilled in the art that there exist other various modifications to the combination of each component and each processing described and that such modifications are encompassed by the scope of the present invention.

In the thirteenth embodiment, the scanning signal to the pixel controlled one step previously and the scanning signal to the pixel controlled two steps previously are utilized to generate a control signal, but a scanning signal to a pixel controlled three steps previously may be further utilized. In such a case, the logical OR of the three scanning signals may be utilized as the control signal. Other modifications may include a structure where scanning signals to pixels controlled more than three steps previously are further utilized.

The transistors Tr10, Tr20 and Tr30 which, with their gate electrode connected to the scanning line, are used as switching elements for writing luminance data may each be structured by a combination of a plurality of transistors, and the capabilities thereof may be structured and realized by arbitrary combination thereof.

Structures of the organic light emitting diodes OLEDs in the pixel circuits shown in FIGS. 23, 25, 26 and 27 are of the multi-layer structure as shown in FIG. 12. The structures may, however, be of the reverse multi-layer structure as shown in FIG. 13. In such a case, the pixel circuit is so structured that the anode and cathode of the organic light emitting diode OLED are replaced with the cathode and anode thereof, respectively, and the anode is connected to a power supply potential Vff which is positive potential and fixed potential. Moreover, the power supply line Vdd which is positive potential is changed to a low potential line Vhh which is ground potential.

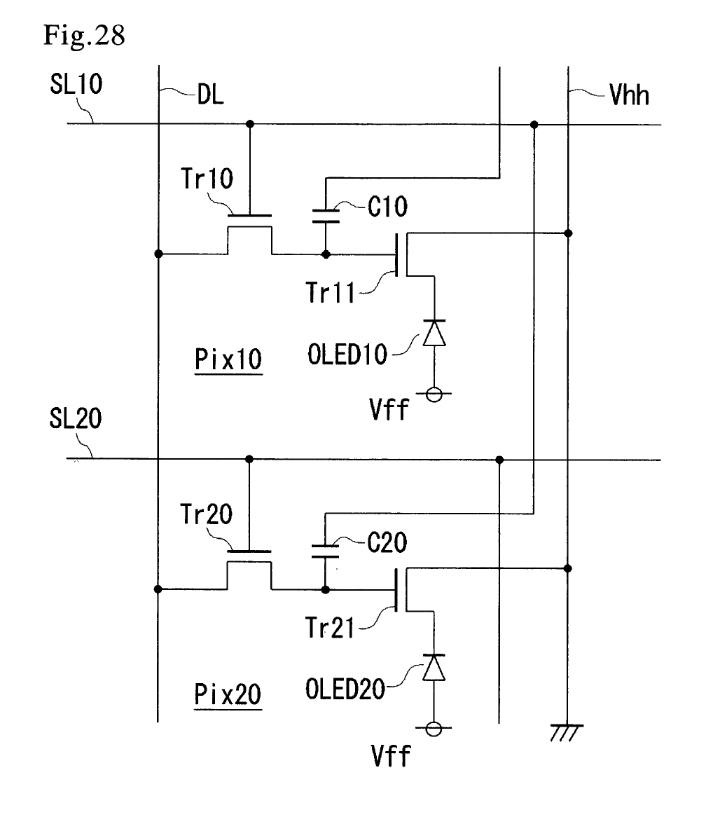

FIG. 28 shows a pixel circuit where the multi-layer structures of the first and second organic light emitting diodes OLED10 and OLED20 shown in FIG. 23 are reversed. It is to be noted here that the pixel circuit may be structured such that the anode of the organic light emitting diode OLED is connected to ground potential and the low potential line Vhh which is ground potential is connected to a negative potential line.

Although the present invention has been described by way of exemplary embodiments, it should be understood that many changes and substitutions may further be made by those skilled in the art without departing from the scope of the present invention which is defined by the appended claims.

What is claimed is:

1. A display apparatus including a current bypass element in parallel with an optical element, wherein voltage having occurred across the optical element is initialized by controlling the current bypass element in accordance with an operation to set luminance data in the optical element.

2. A display apparatus according to claim 1, further including a switch which shuts off a path that supplies current to the optical element when said current bypass element turns on.

3. A display apparatus according to claim 1, wherein a data update instructing signal for setting the luminance data and a signal for controlling said current bypass element are combined into a common signal, and the luminance data is set simultaneously with the initialization of voltage having occurred across the optical element.

4. A display apparatus according to claim 2, wherein a data update instructing signal for setting the luminance data and a signal for controlling said current bypass element are combined into a common signal, and the luminance data is set simultaneously with the initialization of voltage having occurred across the optical element.

5. A display apparatus according to claim 1, wherein a data update instructing signal for setting the luminance data and a signal for controlling the current bypass element are provided separately, so that timing can be set for the initialization of voltage having occurred across the optical element.

6. A display apparatus according to claim 2, wherein a data update instructing signal for setting the luminance data and a signal for controlling the current bypass element are provided separately, so that timing can be set for the initialization of voltage having occurred across the optical element.

7. A display apparatus, comprising:
an optical element which has a first terminal through which current enters, and a second terminal that allows the current to exit; and
an initializing element which actively discharges electric charge accumulated on a side of said first terminal for a predetermined period when current to flow to said optical element is changed.

8. A display apparatus which has a switching element in a path connecting an optical element in series with a drive circuit therefor, wherein the path is opened and closed by controlling said switching element according to an operation that sets luminance data in said drive circuit.

9. A display apparatus according to claim 8, wherein a data update instructing signal for setting the luminance data is connected to said switching element, and said switching element is turned off during setting of the luminance data.

10. A display apparatus in which each pixel includes an optical element, a driving transistor and a power shutoff transistor,
wherein said optical element, said driving transistor and said power shutoff transistor are connected in series with each other, a starting point of said series system is connected to a fixed potential which supplies current to said optical element, and said power shutoff transistor is disposed on a fixed potential side of said optical element.

11. A display apparatus in which each pixel includes an optical element, a driving transistor and a power shutoff transistor,
wherein said driving transistor and said power shutoff transistor are p-channel transistors, and
wherein said optical element, said driving transistor and said power shutoff transistor are connected in series with each other, a starting point of said series system is connected to a fixed potential which supplies current to said optical element, and said power shutoff transistor is disposed on a fixed potential side of said optical element.

12. A display apparatus in which each pixel includes an optical element, a driving transistor and a power shutdown transistor,
wherein said driving transistor is an n-channel transistor and said power shutoff transistor is a p-channel transistor and
wherein said optical element, said driving transistor and said power shutdown transistor are connected in series with each other, a starting point of said series system is connected to a fixed potential which supplies current to said optical element, and said power shutoff transistor is disposed on a fixed potential side of said optical element.

13. A display apparatus, comprising:
an optical element which has a first terminal through which current enters, and a second terminal that allows the current to exit; and
an initializing element which prompts a discharge of electric charge accumulated on a side of said first terminal for a predetermined period when current to flow to said optical element is-changed.

14. A display apparatus according to claim 13, wherein said initializing element is such that said optical element per se operates to discharge the electric charge by shutting off a path of current flowing to said first terminal.

15. A display apparatus in which luminance data to be set for an optical element is stored in the form of a control voltage, wherein there are provided a write period for rewriting the luminance data and an initialization period for discharging electric charge generated across the optical element.

16. A display apparatus according to claim 15, wherein a signal for activating the write period and a signal for activating the initialization period are put to a common use so as to cause to generate the both periods simultaneously.

17. A display apparatus according to claim 15, wherein the write period and the initialization period are simultaneously generated, and a path that supplies current to the optical element is shut off during those periods.

18. A display apparatus according to claim 16, wherein the write period and the initialization period are simultaneously generated, and a path that supplies current to the optical element is shut off during those periods.

19. A display apparatus in which each pixel includes an optical element, a driving transistor and a power shutoff transistor,
wherein said power shutoff transistor is turned off during a period in which a data update instructing signal for writing luminance data of said optical element to said driving transistor is being activated, so that a path which supplies current to said optical element is cut off, and
wherein said power shutoff transistor is turned on after a write period of the luminance data to said driving transistor ends, so that the current supplying path that has been cut off is connected.

20. A display apparatus, comprising:
an optical element;
a drive element which drives said optical element; and
a switch element which controls setting timing that sets a drive capacity of said drive element,
wherein said switch element is controlled by a selection signal that determines the setting timing, and dummy luminance data is set in said drive element by a selection signal for an optical element controlled temporally prior to said optical element.

21. An display apparatus according to claim 20, wherein a value which sets said optical element to an off state is set as the dummy luminance data in said drive element.

22. A display apparatus according to claim 20, wherein, when the selection signal for an optical element controlled temporally prior thereto is activated, a value of the luminance data which is in a floating state between said switch element and said drive element is changed to a direction of becoming the dummy luminance data.

23. A display apparatus according to claim 21, wherein, when the selection signal for an optical element controlled temporally prior thereto is activated, a value of the luminance data which is in a floating state between said switch element and said drive element is changed to a direction of becoming the dummy luminance data.

24. A display apparatus according to claim 20, wherein a path of the selection signal for an optical element controlled temporally prior thereto and a path of the luminance data to be set in said drive element are coupled in capacity, and the dummy luminance data is set via the capacity.

25. A display apparatus according to claim 21, wherein a path of the selection signal for an optical element controlled temporally prior thereto and a path of the luminance data to be set in said drive element are coupled in capacity, and the dummy luminance data is set via the capacity.

26. A display apparatus according to claim 22, wherein a path of the selection signal for an optical element controlled temporally prior thereto and a path of the luminance data to be set in said drive element are coupled in capacity, and the dummy luminance data is set via the capacity.

27. A display apparatus according to claim 23, wherein a path of the selection signal for an optical element controlled temporally prior thereto and a path of the luminance data to be set in said drive element are coupled in capacity, and the dummy luminance data is set via the capacity.

28. A display apparatus according to claim 20, wherein the dummy luminance data is set by a combination of a plurality of selection signals for a plurality of optical elements controlled temporally prior thereto.

29. A display apparatus according to claim 21, wherein the dummy luminance data is set by a combination of a plurality of selection signals for a plurality of optical elements controlled temporally prior thereto.

30. A display apparatus according to claim 22, wherein the dummy luminance data is set by a combination of a plurality of selection signals for a plurality of optical elements controlled temporally prior thereto.

31. A display apparatus according to claim 23, wherein the dummy luminance data is set by a combination of a plurality of selection signals for a plurality of optical elements controlled temporally prior thereto.

32. A display apparatus according to claim 24, wherein the dummy luminance data is set by a combination of a plurality of selection signals for a plurality of optical elements controlled temporally prior thereto.

33. A display apparatus according to claim 25, wherein the dummy luminance data is set by a combination of a plurality of selection signals for a plurality of optical elements controlled temporally prior thereto.

34. A display apparatus according to claim 26, wherein the dummy luminance data is set by a combination of a plurality of selection signals for a plurality of optical elements controlled temporally prior thereto.

35. A display apparatus according to claim 27, wherein the dummy luminance data is set by a combination of a plurality of selection signals for a plurality of optical elements controlled temporally prior thereto.
